(19) United States
(12) Patent Application Publication
(10) Pub. No.: US 2011/0285759 A1
(43) Pub. Date: Nov. 24, 2011

(54) LIQUID CRYSTAL DISPLAY DEVICE AND METHOD FOR DRIVING SAME

(76) Inventor: Tamotsu Sakai, Osaka-Shi (JP)

(21) Appl. No.: 13/144,901

(22) PCT Filed: Nov. 20, 2009
(86) PCT No.: PCT/JP2009/069721

§ 371 Date: Jul. 15, 2011

(30) Foreign Application Priority Data
Mar. 18, 2009 (JP) 2009-065561

(51) Int. Cl. G09G 3/36; G09G 5/10

(52) U.S. Cl. 345/690; 345/89

(57) ABSTRACT

A liquid crystal display device that can be driven at high frequencies without causing display failure due to insufficient charging, flicker, luminance unevenness, etc., is implemented. Source bus lines are driven such that polarities of video signals are reversed every plurality of frames. A display interface circuit is provided with a lookup table that holds a correspondence relationship between a data addition value and a combination of the sum of grayscale values of image data for frames before and after reversal of the polarities of video signals is performed and a row number. During a period of a frame immediately before reversal of the polarities of video signals is performed, the voltages (V1, V2) of video signals applied to the source bus lines are allowed to gradually increase based on data addition values obtained from the lookup table.

### REFERENCE TO RELATED APPLICATIONS

This application is a national stage application under 35 USC 371 of International Application No. PCT/JP2009/69721, filed Nov. 20, 2009, which claims the priority of Japanese Patent Application No. 2009-65561, filed Mar. 18, 2009, the contents of all of which prior applications are incorporated herein by reference.

### TECHNICAL FIELD

The present invention relates to a liquid crystal display device and a method for driving it, and more particularly to a method for driving video signal lines in an active matrix-type liquid crystal display device.

### BACKGROUND ART

Conventionally, there is known an active matrix-type liquid crystal display device including TFTs (thin film transistors) as switching elements. This liquid crystal display device includes a liquid crystal panel formed of two insulating substrates facing each other. One of the substrates of the liquid crystal panel has a plurality of gate bus lines (scanning signal lines) and a plurality of source bus lines (video signal lines) provided thereon in a grid pattern, and has a plurality of pixel formation portions provided thereon at the respective intersections of the plurality of gate bus lines and the plurality of source bus lines. These pixel formation portions are arranged in a matrix form and thereby form a pixel array. FIG. 19 is a circuit diagram showing a configuration of a pixel formation portion Pix. As shown in FIG. 19, each pixel formation portion Pix includes a TFT 10 having a gate electrode 11 connected to a gate bus line GL passing through a corresponding intersection, and having a source electrode 12 connected to a source bus line SL passing through the intersection; a pixel electrode 14 connected to a drain electrode 13 of the TFT 10; a counter electrode (common electrode) 16 and an auxiliary capacitance electrode 18 which are provided so as to be shared by the plurality of pixel formation portions Pix; a liquid crystal capacitance 15 formed by the pixel electrode 14 and the counter electrode 16; and an auxiliary capacitance 17 formed by the pixel electrode 14 and the auxiliary capacitance electrode 18. A pixel capacitance Cp is formed by the liquid crystal capacitance 15 and the auxiliary capacitance 17. Based on a video signal received by the source electrode 12 of each TFT 10 from a source bus line SL when the gate electrode 11 of the TFT 10 receives an active scanning signal from a gate bus line GL, writing of data to a pixel capacitance Cp is performed.

Meanwhile, liquid crystal has the property of deteriorating with continuous application of a DC voltage thereto. Hence, in a liquid crystal display device, an AC voltage is applied to a liquid crystal layer (liquid crystal capacitance). The application of an AC voltage to the liquid crystal layer is implemented by reversing the polarity of an applied voltage to the liquid crystal layer (hereinafter, referred to as a “pixel voltage”) in each pixel formation portion Pix every frame period, i.e., by reversing, every frame period, the polarity of the voltage at the source electrode 12 (hereinafter, referred to as a “video signal voltage”) with reference to the potential of the counter electrode 16. For technologies that embody this, a driving scheme called line-reversal driving and a driving scheme called dot-reversal driving are known.

FIGS. 20A and 20B are signal waveform diagrams for describing changes in video signal voltage in line-reversal driving and dot-reversal driving. FIG. 20A shows a waveform of a gate start pulse signal GSP generated based on a vertical synchronizing signal. FIG. 20B shows a waveform of a video signal when taking a look at a given source bus line SL. As shown in FIG. 20A, pulses of the gate start pulse signal GSP are generated every predetermined period. A period between the pulses of the gate start pulse signal GSP corresponds to one frame period (1F). For the video signal, the polarity is reversed every horizontal scanning period, with reference to a potential Vcom of the counter electrode 16. Namely, the polarity of the video signal is reversed every horizontal scanning period. By such driving, frame-by-frame changes in the polarities of pixel voltages when taking a look at four pixel formation portions Pix of 2 rows×2 columns such as those shown in FIG. 21, are as shown in FIG. 22 in the case of line-reversal driving and are as shown in FIG. 23 in the case of dot-reversal driving. As such, in both line-reversal driving and dot-reversal driving, when taking a look at one source bus line, the polarities of pixel voltages in any frame are reversed every row.

As described above, in both line-reversal driving and dot-reversal driving, the polarity of a video signal for each source bus line is reversed every horizontal scanning period. Meanwhile, in recent years, an increase in the screen size and resolution of display devices (e.g., the resolution is 3840×2160, 4096×2160, 7680×4320, etc.) has been advanced, and accordingly, higher speed driving than that conventionally performed (e.g., the driving frequency is 240 Hz) has been performed. Due to this, the wiring capacitance of each source bus line and the pixel capacitance of each pixel formation portion Pix cannot be sufficiently charged, which may cause display failure resulting from insufficient charging. In particular, when all white display is performed on a normally black mode display device or when all black display is performed on a normally white mode display device, since the potentials of video signals change “from the highest potential to the lowest potential” or “from the lowest potential to the highest potential” every horizontal scanning period, the wiring capacitance of each source bus line is not sufficiently charged. As such, display devices with increased screen size or increased resolution have difficulty in performing high-speed driving without causing display failure resulting from insufficient charging.

Note that, in connection with the invention of the present application, Japanese Patent Application Laid-Open No. 2004-45741 discloses an invention of an image display device that attempts to prevent the occurrence of flicker by reversing the polarities of pixel voltages every frame and stopping such a reversal driving operation every few frames. According to the image display device, frame-by-frame changes in the polarities of pixel voltages are as shown in FIG. 24.

### PRIOR ART DOCUMENTS

### Patent Documents

[Patent Document 1] Japanese Patent Application Laid-Open No. 2004-45741

### SUMMARY OF THE INVENTION

As measures to prevent display failure resulting from insufficient charging such as that described above, the adoption of frame-reversal driving as a driving scheme is considered. When frame-reversal driving is adopted, frame-by-frame changes in the polarities of pixel voltages are as shown in FIG. 25. Specifically, when taking a look at a given source bus line, the polarity of a video signal is maintained at either one of the positive polarity and the negative polarity throughout one frame period. Hence, unlike line-reversal driving or dot-reversal driving where the polarity of a video signal changes every horizontal scanning period, the occurrence of display failure resulting from insufficient charging is suppressed. However, according to frame-reversal driving, since reversal of the polarity of a pixel voltage is performed in the same manner for all of the pixel formation portions Pix in a display unit, flicker occurs due to the difference between the transmittance of liquid crystal obtained when writing of positive polarities to the pixel capacitances is performed and the transmittance of the liquid crystal obtained when writing of negative polarities to the pixel capacitances is performed.

Furthermore, when frame-reversal driving is adopted, even if display with even luminance across the entire surface is performed, a difference may occur between a luminance actually appearing at a screen upper portion and a luminance actually appearing at a screen lower portion, which will be described below. Note that in the following it is premised that writing of data is sequentially performed row by row from the screen upper portion to the screen lower portion during each frame period. Note also that, of pixel formation portions located at four corners (upper left, lower left, upper right, and lower right) in a display unit such as those shown in FIG. 26, those pixel formation portions located at the upper left and lower left corners are respectively denoted by reference characters P1 and P1080, and changes in the potentials of pixel electrodes 14 in those pixel formation portions are focused on.

FIGS. 27A to 27E are signal waveform diagrams for describing the operation of a display device when frame-reversal driving is adopted. FIG. 27A shows a waveform of a gate start pulse signal GSP. FIG. 27B shows a waveform of a data enable signal DE2. FIG. 27C shows a waveform of a video signal applied to a source bus line SL1 of the first column. FIG. 27D shows a waveform of the potential of the pixel electrode 14 in the pixel formation portion P1. FIG. 27E shows a waveform of the potential of the pixel electrode 14 in the pixel formation portion P1080. Note that reference characters DP1 and DP1080 respectively indicate portions where the data enable signal DE2 is active to allow writing of data for the first row and the 1080th row.

In the pixel formation portion P1, the potential of the pixel electrode 14 changes from the negative polarity to the positive polarity with reference to the potential Vcom of the counter electrode 16, in synchronization with timing (time point t1) at which the data enable signal DE2 becomes active for the first time in the first frame. Then, the potential changed to the positive polarity is maintained without being changed almost at all during a period before time point t3 at which the data enable signal DE2 becomes active for the first time in the second frame. Then, at time point t3, the potential of the pixel electrode 14 changes from the positive polarity to the negative polarity. The potential changed to the negative polarity is maintained without being changed almost at all during a period before time point t5 at which the data enable signal DE2 becomes active for the first time in the next frame. As such, the waveform indicating changes in the potential of the pixel electrode 14 in the pixel formation portion P1 is substantially the same as the waveform of the video signal applied to the source bus line SL1.

On the other hand, in the pixel formation portion P1080, when writing of a positive polarity to the pixel capacitance in the pixel formation portion P1 is performed at time point t1, the potential of the pixel electrode 14 (in the pixel formation portion P1080) is pulled to the potential Vcom side of the counter electrode 16. The reason for such is as follows. In the display unit, the pixel electrode 14 in each pixel formation portion Pix and a source bus line SL are arranged at locations close to each other. Hence, as shown in FIG. 19, a parasitic capacitance 19 is present between the pixel electrode 14 and the source bus line SL. Here, at time point t1, the potential of the source bus line SL1 greatly changes from the negative polarity to the positive polarity, and thus, in the pixel formation portion P1080, the potential of the pixel electrode 14 changes in the direction in which the potential of the source bus line SL1 changes, through the parasitic capacitance 19. Accordingly, in the pixel formation portion P1080, the potential of the pixel electrode 14 is pulled to the potential Vcom side of the counter electrode 16. Thereafter, during a period before time point t2 at which the data enable signal DE2 becomes active for the last time in the first frame, off-state leakage occurs in a TFT 10 due to the great difference between the potential of the source bus line SL1 and the potential of the pixel electrode 14 (the potential of a drain electrode of the TFT 10), and accordingly, the potential of the pixel electrode 14 is gradually pulled to the potential Vcom side of the counter electrode 16 (the potential side of the source bus line SL1). Then, at time point t2, the potential of the pixel electrode 14 changes from the negative polarity to the positive polarity with reference to the potential Vcom of the counter electrode 16. The potential changed to the positive polarity is maintained without being changed almost at all during a period before time point t3 at which the data enable signal DE2 becomes active for the first time in the second frame. During a period from time point t3 to time point t5, the potential of the pixel electrode 14 changes in the same manner, but in the opposite polarity, as during a period from time point t1 to time point t3.

Meanwhile, the magnitude of pulling of the potentials of the pixel electrodes 14 in the respective pixel formation portions Pix to the potential Vcom side of the counter electrode 16 increases from at the screen upper portion to at the screen lower portion. In addition, the effective value of a pixel voltage in each frame period is the value of the integral of the pixel voltage in the frame period. Thus, for example, when all white display is performed on a normally black mode display device, the effective value of a pixel voltage in each pixel formation portion Pix decreases from at the screen upper portion to at the screen lower portion. As a result, despite the fact that all white display is supposed to be performed, a gradation image which gradually darkens from at the screen upper portion to at the screen lower portion is displayed, which is visually recognized as luminance unevenness.

As described above, in a liquid crystal display device performing high-speed driving, when line-reversal driving or dot-reversal driving is adopted, display failure due to insufficient charging occurs, and when frame-reversal driving is adopted, flicker and luminance unevenness occur.

An object of the present invention is therefore to implement a liquid crystal display device that can be driven at high frequencies without causing display failure due to insufficient charging, flicker, luminance unevenness, etc.

A first aspect of the present invention is directed to a liquid crystal display device comprising: a plurality of video signal lines for transmitting a plurality of video signals being based on an image signal sent from an external source; a plurality of scanning signal lines intersecting with the plurality of video signal lines; a plurality of pixel formation portions arranged in a matrix form at respective intersection of the plurality of video signal lines and the plurality of scanning signal lines; and a driving control unit for driving the plurality of video signal lines and selectively driving the plurality of scanning signal lines, wherein

each pixel formation portion includes a pixel capacitance that is charged with a voltage of a video signal which is transmitted through a video signal line passing through a corresponding intersection when a scanning signal line passing through the corresponding intersection is selected,

the driving control unit includes:
a polarity determining unit that determines polarities of the plurality of video signals such that a polarity of a video signal applied to each video signal line is reversed every plurality of frames; and
a video signal line drive circuit that applies, as the video signal, a grayscale voltage among a plurality of grayscale voltages associated in advance with a plurality of displayable grayscale values for each of a positive polarity and a negative polarity, to each video signal line, the grayscale voltage being associated with a combination of a grayscale value of the image signal and a polarity determined by the polarity determining unit, and

during a period of a first frame, a grayscale voltage applied to each video signal line as the video signal is increased according to a selected scanning signal line, the first frame being a frame immediately before the polarities of the plurality of video signals are reversed.

According to a second aspect of the present invention, in the first aspect of the present invention,

the driving control unit further includes a grayscale value adding unit that adds a data addition value to a grayscale value of the image signal for the first frame among grayscale values for determining grayscale voltages to be applied to the respective video signal lines as the video signals when each scanning signal line is selected, the data addition value being determined based on grayscale values of the image signal for the first frame and a second frame and an order in which the scanning signal line is selected in the second frame, and the second frame being a next frame to the first frame.

According to a third aspect of the present invention, in the second aspect of the present invention,

when a sum of the grayscale value of the image signal for the first frame and the grayscale value of the image signal for the second frame is constant, the grayscale value adding unit increases the value of the data addition value as an order in which the scanning signal lines are selected gets later.

According to a fourth aspect of the present invention, in the second aspect of the present invention,

when an order in which the scanning signal lines are selected is constant, the grayscale value adding unit decreases the value of the data addition value as a sum of the grayscale value of the image signal for the first frame and the grayscale value of the image signal for the second frame approaches a maximum value or a minimum value that the sum can take.

According to a fifth aspect of the present invention, in the second aspect of the present invention,

the driving control unit further includes a lookup table in which a combination of a sum of the grayscale values of the image signal for the first frame and the second frame and an order in which the scanning signal lines are selected is associated with the data addition value, and

the grayscale value adding unit obtains the data addition value from the lookup table.

According to a sixth aspect of the present invention, in the first aspect of the present invention,

the video signal line drive circuit applies video signals of different polarities to adjacent video signal lines during a period of each frame.

A seventh aspect of the present invention is directed to a liquid crystal display device comprising: a plurality of video signal lines for transmitting a plurality of video signals being based on an image signal sent from an external source; a plurality of scanning signal lines intersecting with the plurality of video signal lines; a plurality of pixel formation portions arranged in a matrix form at respective intersection of the plurality of video signal lines and the plurality of scanning signal lines; and a driving control unit for driving the plurality of video signal lines and selectively driving the plurality of scanning signal lines, wherein

each pixel formation portion includes a pixel capacitance that is charged with a voltage of a video signal which is transmitted through a video signal line passing through a corresponding intersection when a scanning signal line passing through the corresponding intersection is selected,

the driving control unit includes:
a polarity determining unit that determines, based on luminance data obtained from the image signal for a first frame and a second frame, a polarity of a video signal to be applied to each video signal line during a period of the second frame, the first and second frames being any two consecutive frames and the second frame being a subsequent frame of the two frames; and
a video signal line drive circuit that applies, during a period of each frame, a video signal of a polarity determined by the polarity determining unit to each video signal line without changing the polarity, and

the polarity determining unit includes a first polarity determining unit that determines, if there is a difference of a predetermined magnitude or more between the luminance data for the first frame and the luminance data for the second frame, the polarity of the video signal to be applied to each video signal line during the period of the second frame to be an opposite polarity to a polarity of a video signal applied to the video signal line during a period of the first frame.

According to an eighth aspect of the present invention, in the seventh aspect of the present invention,

the polarity determining unit further includes an average luminance calculating unit that calculates an average luminance level of the image signal for each frame as the luminance data, and

the first polarity determining unit determines, if there is a difference of a predetermined first threshold value or more between the average luminance level for the first frame and the average luminance level for the second frame, the polarity of the video signal to be applied to each video signal line during the period of the second frame to be an opposite polarity to a polarity of a video signal applied to the video signal line during the period of the first frame.

According to a ninth aspect of the present invention, in the eighth aspect of the present invention,

the first threshold value is set to any value between 20% and 40%, inclusive.

According to a tenth aspect of the present invention, in the eighth aspect of the present invention,

the liquid crystal display device further comprises a polarity difference holding unit that holds, as a polarity difference, a difference between a number of occurrences of a positive polarity and a number of occurrences of a negative polarity, based on the polarities determined by the polarity determining unit, wherein

the polarity determining unit further includes a second polarity determining unit that determines, if the average luminance level for the second frame is less than or equal to a predetermined second threshold value or greater than or equal to a predetermined third threshold value, the polarity of the video signal to be applied to each video signal line during the period of the second frame to be a polarity whose number of occurrences is lesser, based on the polarity difference.

According to an eleventh aspect of the present invention, in the tenth aspect of the present invention,

the second threshold value is set to any value between 0% and 10%, inclusive and

the third threshold value is set to any value between 90% and 100%, inclusive.

According to a twelfth aspect of the present invention, in the tenth aspect of the present invention,

the polarity determining unit further includes a third polarity determining unit that determines, if the polarity difference is greater than or equal to a predetermined fourth threshold value, the polarity of the video signal to be applied to each video signal line during the period of the second frame to be an opposite polarity to a polarity of a video signal applied to the video signal line during the period of the first frame.

According to a thirteenth aspect of the present invention, in the seventh aspect of the present invention,

the video signal line drive circuit applies video signals of different polarities to adjacent video signal lines during a period of each frame.

A fourteenth aspect of the present invention is directed to a method for driving a liquid crystal display device including: a plurality of video signal lines for transmitting a plurality of video signals being based on an image signal sent from an external source; a plurality of scanning signal lines intersecting with the plurality of video signal lines; and a plurality of pixel formation portions arranged in a matrix form at respective intersection of the plurality of video signal lines and the plurality of scanning signal lines, the driving method comprising:

a driving control step of driving the plurality of video signal lines and selectively driving the plurality of scanning signal lines, wherein

each pixel formation portion includes a pixel capacitance that is charged with a voltage of a video signal which is transmitted through a video signal line passing through a corresponding intersection when a scanning signal line passing through the corresponding intersection is selected,

the driving control step includes:
a polarity determining step of determining polarities of the plurality of video signals such that a polarity of a video signal applied to each video signal line is reversed every plurality of frames; and
a video signal line driving step of applying, as the video signal, a grayscale voltage among a plurality of grayscale voltages associated in advance with a plurality of displayable grayscale values for each of a positive polarity and a negative polarity, to each video signal line, the grayscale voltage being associated with a combination of a grayscale value of the image signal and a polarity determined in the polarity determining step, and

during a period of a first frame, a grayscale voltage applied to each video signal line as the video signal is increased according to a selected scanning signal line, the first frame being a frame immediately before the polarities of the plurality of video signals are reversed.

In addition, variants that are grasped by referring to the embodiment and the drawings in the fourteenth aspect of the present invention are considered to be means for solving the problems.

A twentieth aspect of the present invention is directed to a method for driving a liquid crystal display device including: a plurality of video signal lines for transmitting a plurality of video signals being based on an image signal sent from an external source; a plurality of scanning signal lines intersecting with the plurality of video signal lines; and a plurality of pixel formation portions arranged in a matrix form at respective intersection of the plurality of video signal lines and the plurality of scanning signal lines, the driving method comprising:

a driving control step of driving the plurality of video signal lines and selectively driving the plurality of scanning signal lines, wherein

each pixel formation portion includes a pixel capacitance that is charged with a voltage of a video signal which is transmitted through a video signal line passing through a corresponding intersection when a scanning signal line passing through the corresponding intersection is selected,

the driving control step includes:
a polarity determining step of determining, based on luminance data obtained from the image signal for a first frame and a second frame, a polarity of a video signal to be applied to each video signal line during a period of the second frame, the first and second frames being any two consecutive frames and the second frame being a subsequent frame of the two frames; and
a video signal line driving step of applying, during a period of each frame, a video signal of a polarity determined in the polarity determining step to each video signal line without changing the polarity, and

the polarity determining step includes a first polarity determining step of determining, if there is a difference of a predetermined magnitude or more between the luminance data for the first frame and the luminance data for the second frame, the polarity of the video signal to be applied to each video signal line during the period of the second frame to be an opposite polarity to a polarity of a video signal applied to the video signal line during a period of the first frame.

In addition, variants that are grasped by referring to the embodiment and the drawings in the twentieth aspect of the present invention are considered to be means for solving the problems.

According to the first aspect of the present invention, during each frame period, the polarities of video signals applied to the respective video signal lines are maintained at either one of the positive polarity and the negative polarity. Hence, even if high-frequency driving is performed, sufficient time to charge the wiring capacitance of each video signal line and the pixel capacitance of each pixel formation portion is secured, and thus, the occurrence of display failure due to insufficient charging is prevented. In addition, reversal of the polarities of video signals is performed every plurality of frames and during a frame immediately before reversal of the polarities of video signals is performed, voltages higher than voltages originally supposed to be applied are applied to the video signal lines according to a selected scanning signal line. Hence, fluctuations in pixel electrode potential due to the presence of parasitic capacitances between the pixel electrodes and the video signal lines and off-state leakage in the TFTs in the pixel formation portions are suppressed. By this, the occurrence of flicker and luminance unevenness (display unevenness resulting from the difference in luminance between the screen upper portion and the screen lower portion) which conventionally occur when frame-reversal driving is adopted is suppressed. Thus, the display device can be driven at high frequencies without causing display failure due to insufficient charging, flicker, luminance unevenness, etc.

According to the second aspect of the present invention, during a frame immediately before reversal of the polarities of video signals is performed, taking into account the grayscale values of the image signal for the first frame and the second frame and the order in which the scanning signal lines are selected, voltages higher than voltages originally supposed to be applied are applied to the video signal lines. Hence, the occurrence of flicker and luminance unevenness which conventionally occur when frame-reversal driving is adopted is effectively suppressed.

According to the third aspect of the present invention, during a frame immediately before reversal of the polarities of video signals is performed, higher voltages are applied to the video signal lines when a scanning signal line that requires a longer time to be selected after polarity reversal is selected. Hence, fluctuations in pixel electrode potential due to off-state leakage in the TFTs in the pixel formation portions are effectively suppressed, and accordingly, the occurrence of luminance unevenness based on fluctuations in pixel electrode potential is effectively suppressed.

According to the fourth aspect of the present invention, during a frame immediately before reversal of the polarities of video signals is performed, taking into account the transmittance of liquid crystal, voltages higher than voltages originally supposed to be applied are applied to the video signal lines. Hence, the occurrence of flicker and luminance unevenness which conventionally occur when frame-reversal driving is adopted is more effectively suppressed.

According to the fifth aspect of the present invention, a correspondence relationship between a data addition value and a combination of the sum of the grayscale values of the image signal for the first frame and the second frame and the order in which the scanning signal lines are selected is stored in a lookup table. Hence, the correspondence relationship can be easily changed externally when necessary.

According to the sixth aspect of the present invention, during any frame period, the polarities of video signals applied to adjacent video signal lines differ from each other. Hence, flicker is further less likely to be visually recognized.

According to the seventh aspect of the present invention, during each frame period, the polarities of video signals applied to the respective video signal lines are maintained at either one of the positive polarity and the negative polarity. Hence, even if high-frequency driving is performed, sufficient time to charge the wiring capacitance of each video signal line and the pixel capacitance of each pixel formation portion is secured, and thus, the occurrence of display failure due to insufficient charging is prevented. In addition, reversal of the polarities of video signals is performed when there is a difference of a predetermined magnitude or more between luminance data units for two consecutive frames. Hence, reversal of the polarities of video signals can be performed at timing at which flicker is not so conspicuous.

According to the eighth aspect of the present invention, reversal of the polarities of video signals is performed when there is a difference of a predetermined magnitude or more between the average luminance levels of the image signal for two consecutive frames. Hence, as in the seventh aspect of the present invention, reversal of the polarities of video signals can be performed at timing at which flicker is not so conspicuous.

According to the ninth aspect of the present invention, reversal of the polarities of video signals is performed mainly at the timing of switching of scenes. Hence, the occurrence of flicker can be more effectively prevented.

According to the tenth aspect of the present invention, when an image darker than a predetermined brightness or an image brighter than a predetermined brightness is displayed, the polarities of video signals are determined so as to reduce the difference between the number of occurrences of a positive polarity and the number of occurrences of a negative polarity. Hence, without flicker being easily visually recognized, a bias in the polarity of a liquid crystal applied voltage is reduced, whereby deterioration of liquid crystal can be suppressed.

According to the eleventh aspect of the present invention, the time when reversal of the polarities of video signals is performed to reduce the difference between the number of occurrences of a positive polarity and the number of occurrences of a negative polarity is when an overall dark image or an overall bright image is displayed. Hence, the occurrence of flicker resulting from the polarity reversal is prevented and thus deterioration of the liquid crystal can be effectively suppressed.

According to the twelfth aspect of the present invention, when the difference between the number of occurrences of a positive polarity and the number of occurrences of a negative polarity is greater than or equal to the fourth threshold value, the polarities of video signals are reversed. Hence, by setting an appropriate value for the fourth threshold value, when still image display is performed, too, reversal of the polarities of video signals is performed whenever necessary, and thus, deterioration of the liquid crystal is suppressed.

According to the thirteenth aspect of the present invention, during any frame period, the polarities of video signals applied to adjacent video signal lines differ from each other. Hence, flicker is further less likely to be visually recognized.

### BRIEF DESCRIPTION OF THE DRAWINGS

FIGS. 1A to 1D are signal waveform diagrams for describing a method for driving an active matrix-type liquid crystal display device according to a first embodiment of the present invention.

FIG. 2 is a block diagram showing an overall configuration of the liquid crystal display device in the first embodiment.

FIG. 3 is a block diagram showing a configuration of a source driver in the first embodiment.

FIG. 4 is a diagram showing frame-by-frame changes in the polarities of pixel voltages in the first embodiment.

FIGS. 5A and 5B are diagrams showing the polarities of pixel voltages appearing on the entire screen in the first embodiment.

FIG. 6 is a diagram for describing how much higher voltage is applied to each source bus line upon performing display with even luminance across the entire screen than a video signal voltage originally supposed to be applied, according to the location on the screen in the first embodiment.

FIG. 7 is a diagram schematically showing data stored in a lookup table in the first embodiment.

FIG. 8 is a diagram showing the transmittance characteristics of liquid crystal in the first embodiment.

FIGS. 9A and 9B are diagrams showing the polarities of pixel voltages appearing on the entire screen in a variant of the first embodiment.

FIG. 10 is a block diagram showing an overall configuration of a liquid crystal display device in a second embodiment of the present invention.

FIG. 11 is a flowchart showing the procedural steps of a polarity determination process in the second embodiment.

FIG. 12 is a flowchart showing the procedural steps of a polarity determination process in a variant of the second embodiment.

FIG. 13 is a block diagram showing a configuration of a main part of a liquid crystal display device according to a reference example that prevents the occurrences of flicker and luminance unevenness which conventionally occur when frame-reversal driving is adopted.

FIG. 14 is a circuit diagram showing a detailed exemplary configuration of a switching circuit in the reference example.

FIG. 15 is a block diagram showing another exemplary configuration of a main part of a liquid crystal display device in the reference example.

FIGS. 16A to 16E are signal waveform diagrams for describing a driving method in the reference example.

FIGS. 17A and 17B are diagrams for describing effects brought about by the reference example.

FIGS. 18A to 18E are signal waveform diagrams for describing another driving method in the reference example.

FIG. 19 is a circuit diagram showing a configuration of a pixel formation portion.

FIGS. 20A and 20B are signal waveform diagrams for describing changes in video signal voltage in line-reversal driving and dot-reversal driving in a conventional example.

FIG. 21 is a diagram showing four pixel formation portions of 2 rows×2 columns.

FIG. 22 is a diagram showing frame-by-frame changes in the polarities of pixel voltages when line-reversal driving is adopted, in the conventional example.

FIG. 23 is a diagram showing frame-by-frame changes in the polarities of pixel voltages when dot-reversal driving is adopted, in the conventional example.

FIG. 24 is a diagram showing frame-by-frame changes in the polarities of pixel voltages in an image display device disclosed in Japanese Patent Application Laid-Open No. 2004-45741.

FIG. 25 is a diagram showing frame-by-frame changes in the polarities of pixel voltages when frame-reversal driving is adopted, in the conventional example.

FIG. 26 is a diagram showing four pixel formation portions at four corners of a display unit.

FIGS. 27A to 27E are signal waveform diagrams for describing the operation of a display device when frame-reversal driving is adopted, in the conventional example.

### DETAILED DESCRIPTION OF THE INVENTION

Embodiments of the present invention will be described below with reference to the accompanying drawings.

### 1. First Embodiment

### 1.1 Overall Configuration and Operation

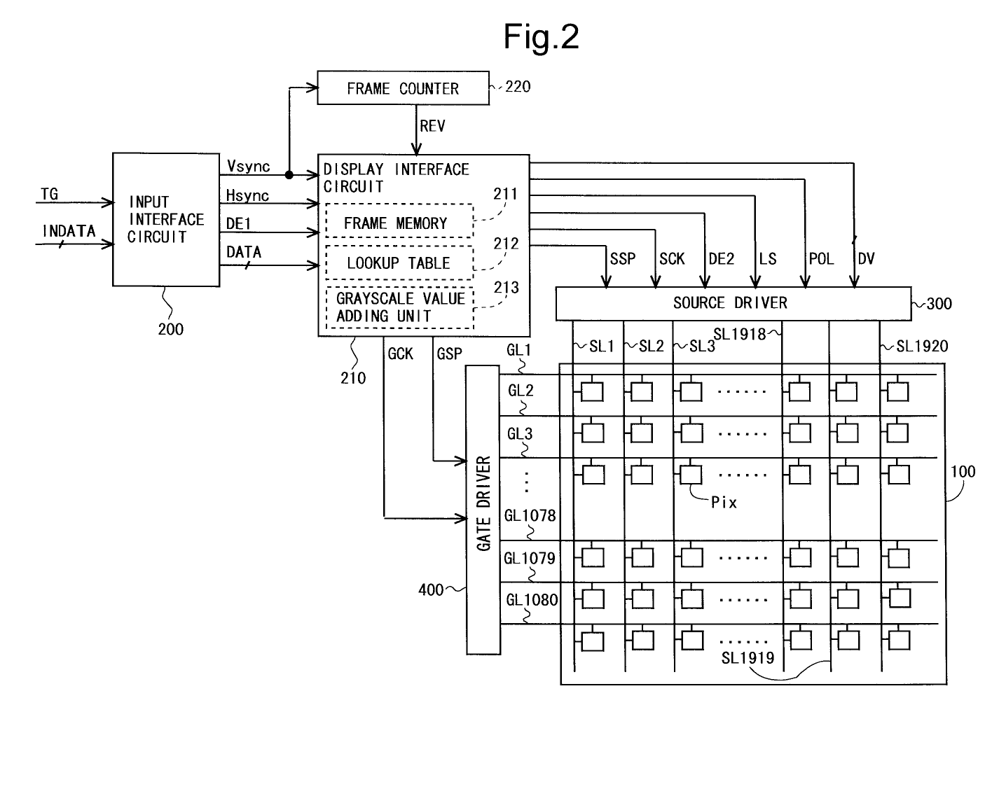

FIG. 2 is a block diagram showing an overall configuration of an active matrix-type liquid crystal display device according to a first embodiment of the present invention. The liquid crystal display device includes a display unit 100, an input interface circuit 200, a display interface circuit 210, a frame counter 220, a source driver (video signal line drive circuit) 300, and a gate driver (scanning signal line drive circuit) 400. The display interface circuit 210 includes a frame memory 211, a lookup table 212, and a grayscale value adding unit 213. Note that in the description a portion of the region of the display unit 100 shown in FIG. 2 close to the source driver 300 is referred to as the “screen upper portion” and a portion of the region far away from the source driver 300 is referred to as the “screen lower portion”. It is premised that writing of data is sequentially performed row by row from the screen upper portion to the screen lower portion during each frame period.

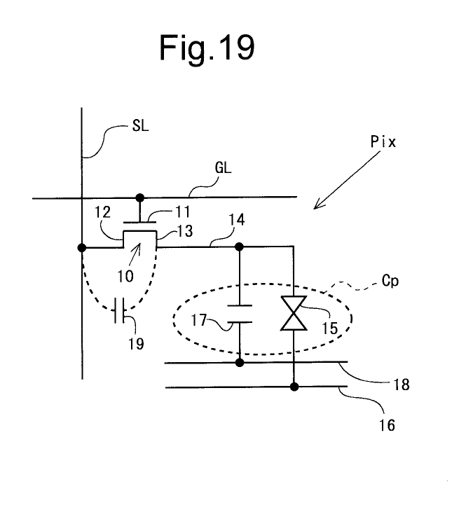

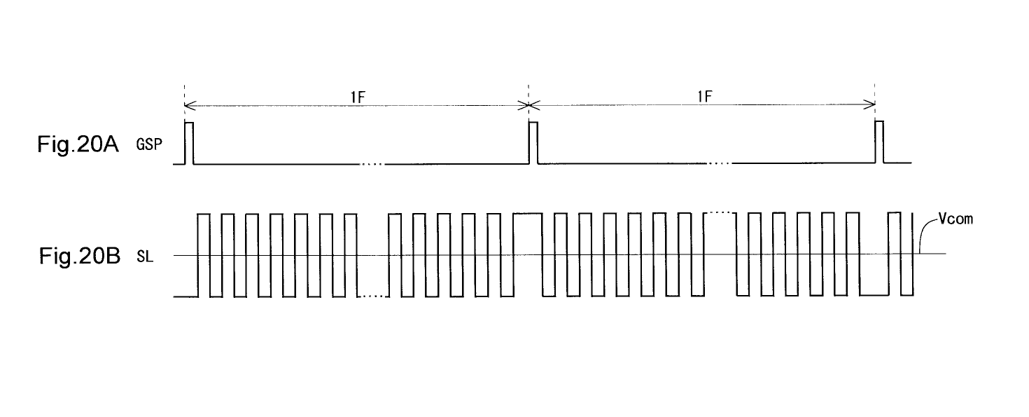

The display unit 100 includes a plurality of (here, 1920) source bus lines (video signal lines) SL1 to SL1920, a plurality of (here, 1080) gate bus lines (scanning signal lines) GL1 to GL1080, and a plurality of (1920×1080) pixel formation portions Pix provided at the respective intersections of the plurality of source bus lines SL1 to SL1920 and the plurality of gate bus lines GL1 to GL1080. Note that the configuration of the pixel formation portions Pix is the same as that in the conventional example shown in FIG. 19 and thus description thereof is omitted.

The input interface circuit 200 receives a timing signal group TG including a synchronizing signal, etc., and input image data INDATA from an external source, and outputs a vertical synchronizing signal Vsync, a horizontal synchronizing signal Hsync, and a data enable signal DE1 which serve as timing signals, and image data DATA. The frame counter 220 receives the vertical synchronizing signal Vsync outputted from the input interface circuit 200, and outputs a reversal instruction signal REV for instructing to reverse the polarities of video signals. Note that in the present embodiment the polarities of video signals are reversed every three frame periods.

The display interface circuit 210 receives the vertical synchronizing signal Vsync, the horizontal synchronizing signal Hsync, the data enable signal DE1, and the image data DATA which are outputted from the input interface circuit 200, and the reversal instruction signal REV outputted from the frame counter 220, and outputs a digital video signal DV and a source start pulse signal SSP, a source clock signal SCK, a data enable signal DE2, a latch strobe signal LS, a polarity instruction signal POL, agate start pulse signal GSP, and a gate clock signal GCK which are used to control image display on the display unit 100. In the frame memory 211 is stored image data DATA for two consecutive frames. In the lookup table 212 is stored data for determining the potentials of video signals for a frame period immediately before reversal of the polarities of the video signals is performed. The grayscale value adding unit 213 performs a process of determining a value for correcting a grayscale value (a data addition value which will be described later) and adding the value to an original grayscale value.

The source driver 300 receives the source start pulse signal SSP, the source clock signal SCK, the data enable signal DE2, the latch strobe signal LS, the polarity instruction signal POL, and the digital video signal DV which are outputted from the display interface circuit 210, and applies driving video signals to the source bus lines SL1 to SL1920, respectively. The gate driver 400 repeats application of an active scanning signal to each of the gate bus lines GL1 to GL1080 in cycles of one frame period (one vertical scanning period), based on the gate start pulse signal GSP and the gate clock signal GCK which are outputted from the display interface circuit 210.

By thus applying the driving video signals to the source bus lines SL1 to SL1920, respectively, and applying the scanning signals to the gate bus lines GL1 to GL1080, respectively, an image based on the input image data INDATA is displayed on the display unit 100.

Note that, in the present embodiment, a driving control unit is implemented by the input interface circuit 200, the display interface circuit 210, the frame counter 220, the source driver 300, and the gate driver 400, and a polarity determining unit is implemented by the frame counter 220.

### 1.2 Configuration of the Source Driver

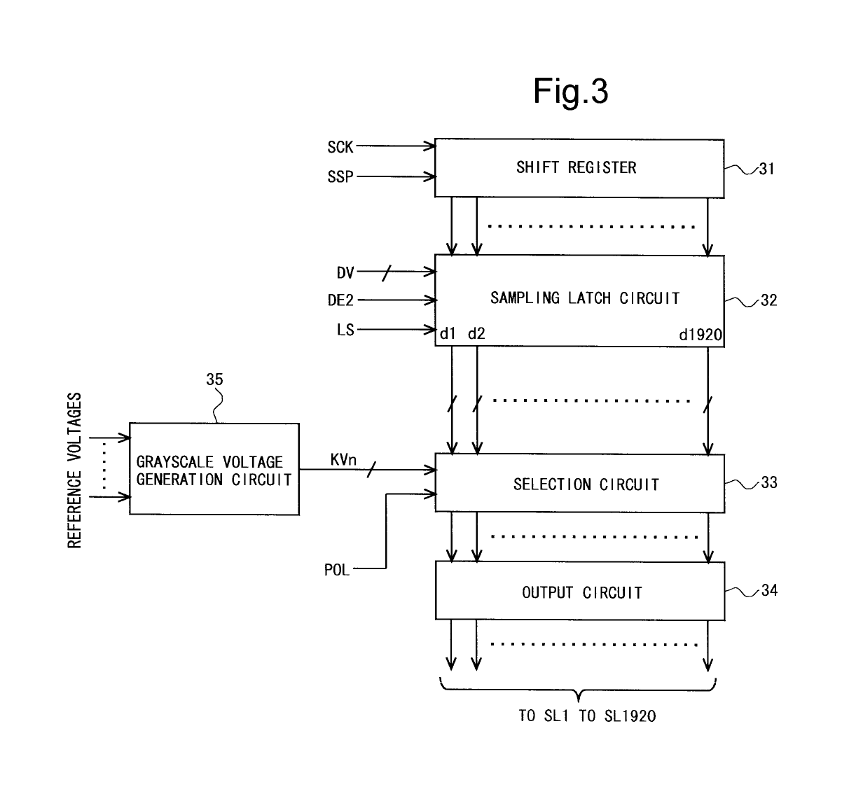

FIG. 3 is a block diagram showing a configuration of the source driver 300 in the present embodiment. The source driver 300 includes a shift register 31, a sampling latch circuit 32, a selection circuit 33, an output circuit 34, and a grayscale voltage generation circuit 35.

A source start pulse signal SSP and a source clock signal SCK are inputted into the shift register 31. The shift register 31 sequentially transfers pulses included in the source start pulse signal SSP from an input terminal to an output terminal, based on the source clock signal SCK. According to the transfer of pulses, sampling pulses for the respective source bus lines SL1 to SL1920 are sequentially outputted from the shift register 31. The sampling pulses are sequentially inputted into the sampling latch circuit 32.

The sampling latch circuit 32 samples a digital video signal DV at the timing of the sampling pulses during a period during which a data enable signal DE2 is active. Then, the sampling latch circuit 32 simultaneously outputs the sampled digital video signal DV at the timing of the pulses of a latch strobe signal LS, as internal image signals d1 to d1920.

The grayscale voltage generation circuit 35 outputs, as a grayscale voltage group KVn, voltages corresponding to, for example, 256 grayscale levels for each of the positive and negative polarities, based on a plurality of reference voltages provided from a predetermined power supply circuit.

The selection circuit 33 selects and outputs any of the voltages included in the grayscale voltage group KVn outputted from the grayscale voltage generation circuit 35, based on the internal image signals d1 to d1920 outputted from the sampling latch circuit 32 and a polarity instruction signal POL outputted from the display interface circuit 210. The voltages outputted from the selection circuit 33 are inputted into the output circuit 34. The output circuit 34 performs impedance transformation on the voltages outputted from the selection circuit 33, using a voltage follower, for example, and outputs the transformed voltages to the source bus lines SL1 to SL1920 as driving video signals.

### 1.3 Driving Method>

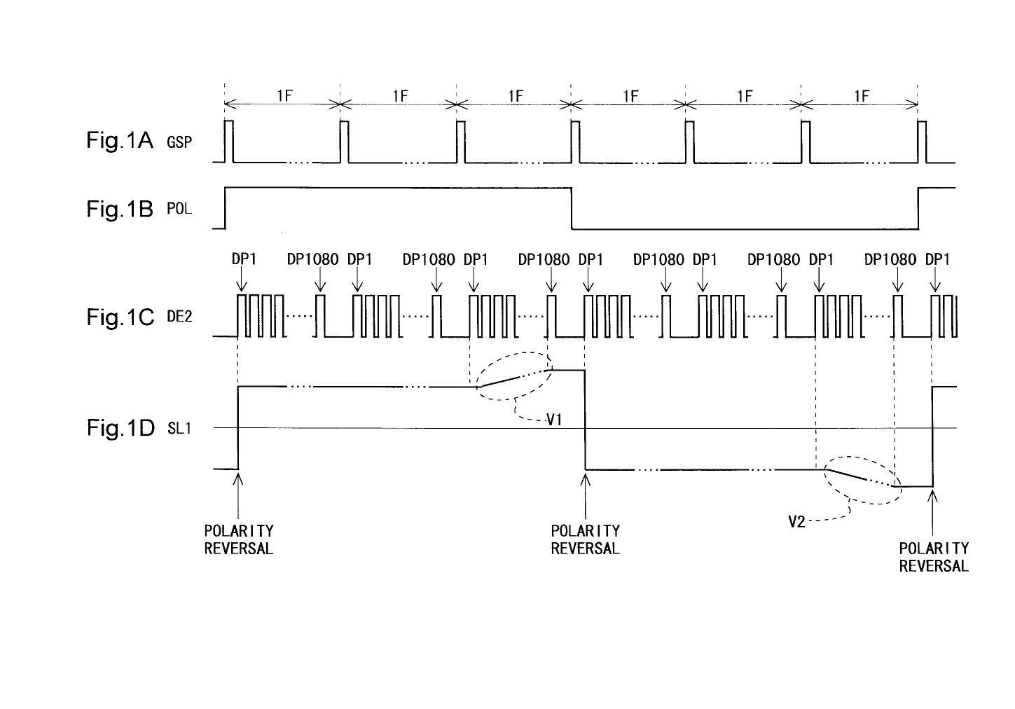

FIGS. 1A to 1D are signal waveform diagrams for describing a driving method in the present embodiment. FIG. 1A shows a waveform of a gate start pulse signal GSP. FIG. 1B shows a waveform of a polarity instruction signal POL. FIG. 1C shows a waveform of a data enable signal DE2. FIG. 1D shows a waveform of a video signal applied to the source bus line SL1 of the first column. Note that reference characters DP1 and DP1080 respectively indicate portions where the data enable signal DE2 is active to allow writing of data for the first row and the 1080th row. Note also that here it is assumed that display with even luminance across the entire surface such as grayscale is performed, unless otherwise noted.

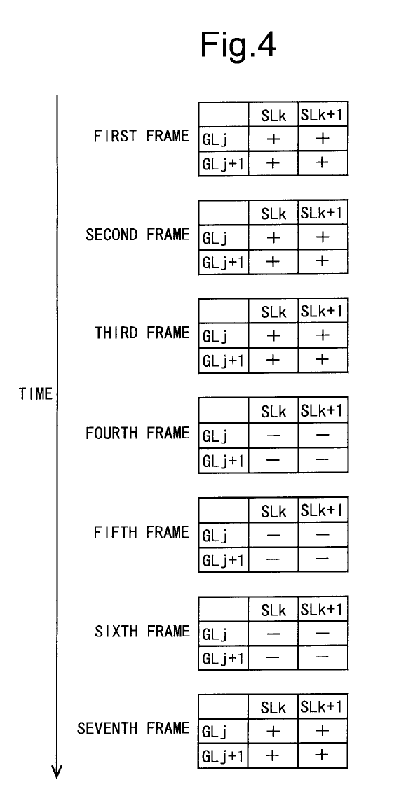

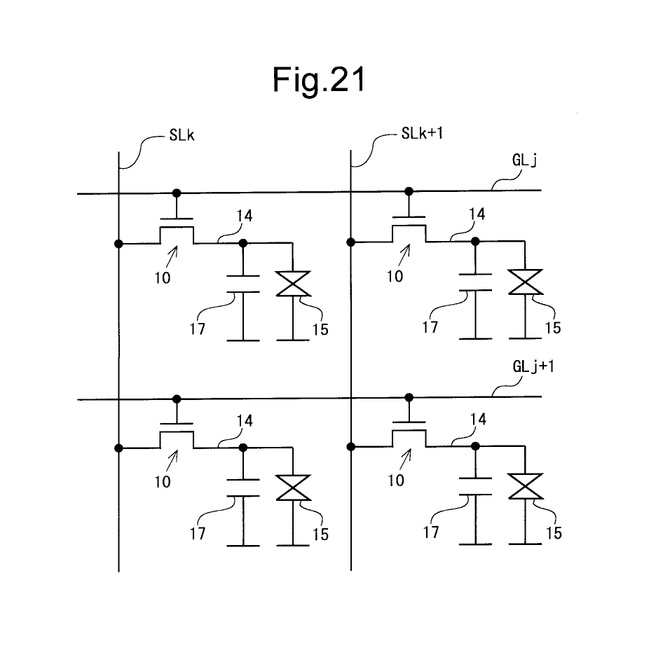

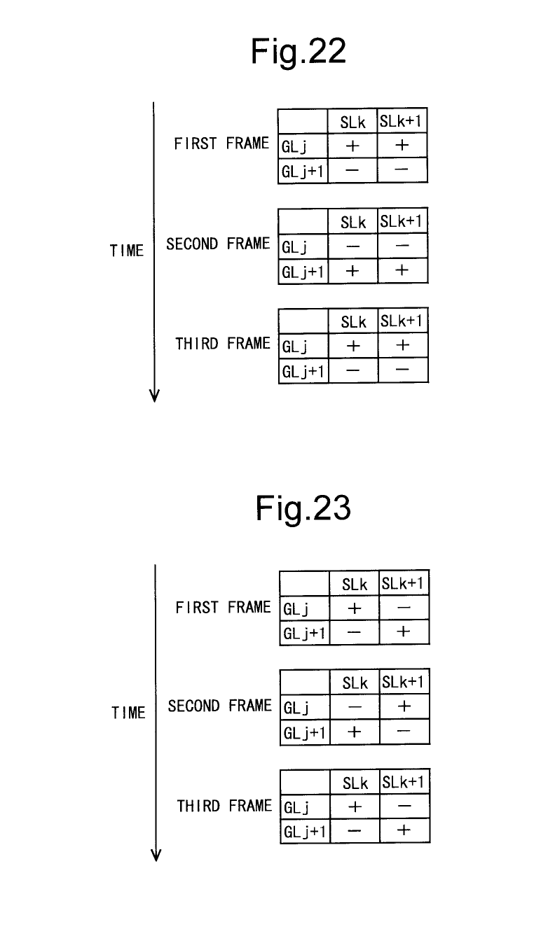

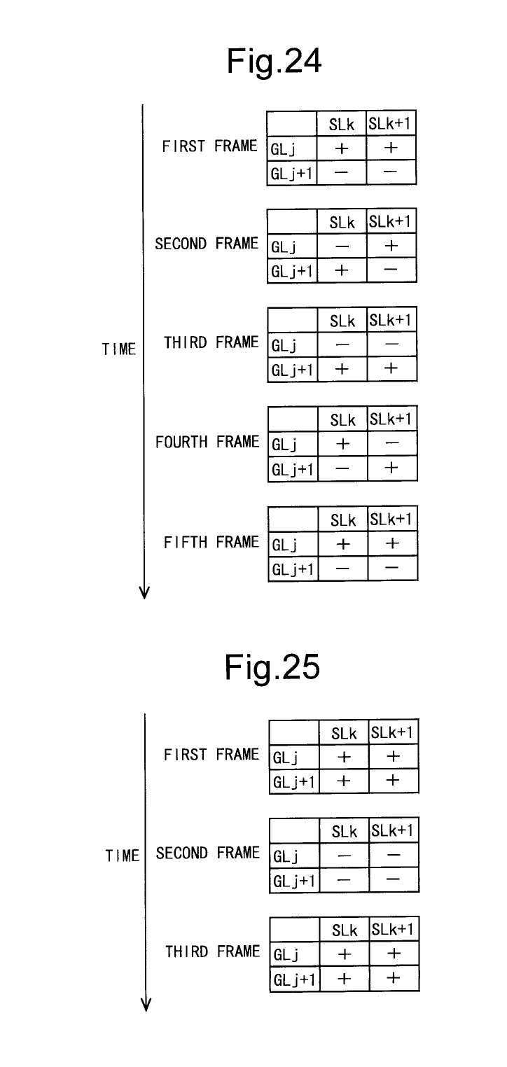

As shown in FIGS. 1A and 1B, in the present embodiment, the logic level of the polarity instruction signal POL changes every third generation of a pulse of the gate start pulse signal GSP. By this, the polarities of video signals applied to the respective source bus lines and the polarities of pixel voltages in the respective pixel formation portions Pix are reversed every three frame periods. In addition, in the present embodiment, in each frame period, the polarities of video signals for all of the source bus lines SL1 to SL1920 are set to the same polarity. Therefore, when taking a look at four pixel formation portions Pix such as those shown in FIG. 21, the polarities of pixel voltages change as shown in FIG. 4.

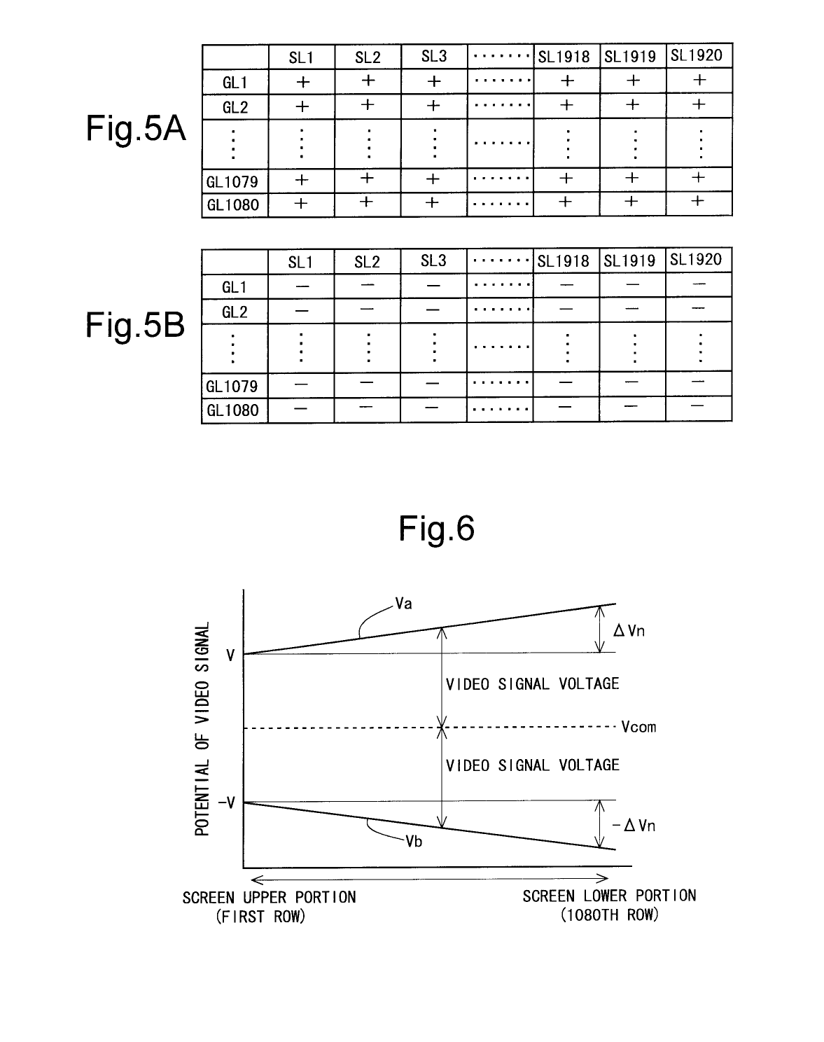

Specifically, when taking a look at the entire screen, polarities such as those shown in FIG. 5A and polarities such as those shown in FIG. 5B alternately appear every three frame periods.

Meanwhile, in a display device adopting frame-reversal driving, as described previously, due to the potentials of pixel electrodes 14 being pulled to the potential Vcom side of the counter electrode 16, a difference in luminance occurs between the screen upper portion and the screen lower portion (luminance unevenness occurs). Also, the magnitude of the pulling increases from at the screen upper portion to at the screen lower portion. Hence, in the present embodiment, in order that the value of the integral of a pixel voltage in each pixel formation portion Pix for each frame period is the value of a pixel voltage originally supposed to be applied, a video signal voltage is allowed to gradually increase as indicated by reference characters V1 and V2 in FIG. 1 during a frame period immediately before polarity reversal is performed. Specifically, a voltage larger than a video signal voltage originally supposed to be applied is applied to each source bus line such that the magnitude of the voltage increases from at the screen upper portion to at the screen lower portion, which will be described in more detail with reference to FIGS. 6 to 8.

FIG. 6 is a diagram for describing how much higher voltage is applied to each source bus line upon performing display with even luminance across the entire screen than a video signal voltage originally supposed to be applied, according to the location on the screen. During a frame period which is immediately before polarity reversal is performed and during which positive polarity writing is to be performed, a video signal higher in potential by ΔVn than a potential V of an original video signal is provided to each source bus line. ΔVn is hereinafter referred to as a “voltage addition value”. The magnitude of the voltage addition value ΔVn is set so as to gradually increase from at the screen upper portion to at the screen lower portion, as indicated by reference character Va in FIG. 6. During a frame period which is immediately before polarity reversal is performed and during which negative polarity writing is to be performed, a video signal lower in potential by the above-described voltage addition value ΔVn than a potential −V of an original video signal is provided to each source bus line. As indicated by reference character Vb in FIG. 6, the magnitude of the voltage addition value ΔVn at this time is also set so as to gradually increase from at the screen upper portion to at the screen lower portion.

Meanwhile, in a liquid crystal display device, video signal voltages are determined based on the grayscale values of an image to be displayed. Therefore, in order to determine a video signal voltage actually applied to each source bus line (a voltage larger by the above-described voltage addition value ΔVn than a video signal voltage originally supposed to be applied to the source bus line), for a grayscale value, too, a value to be added to the grayscale value of an image to be displayed (the value is hereinafter referred to as a “data addition value”) ΔKn should be obtained. Hence, in the present embodiment, in the grayscale value adding unit 213 in the display interface circuit 210 shown in FIG. 2, a data addition value ΔKn is determined by referring to the lookup table 212 based on image data DATA for two frames stored in the frame memory 211. Then, further, in the grayscale value adding unit 213, the above-described data addition value ΔKn is added to the grayscale value of an image to be displayed.

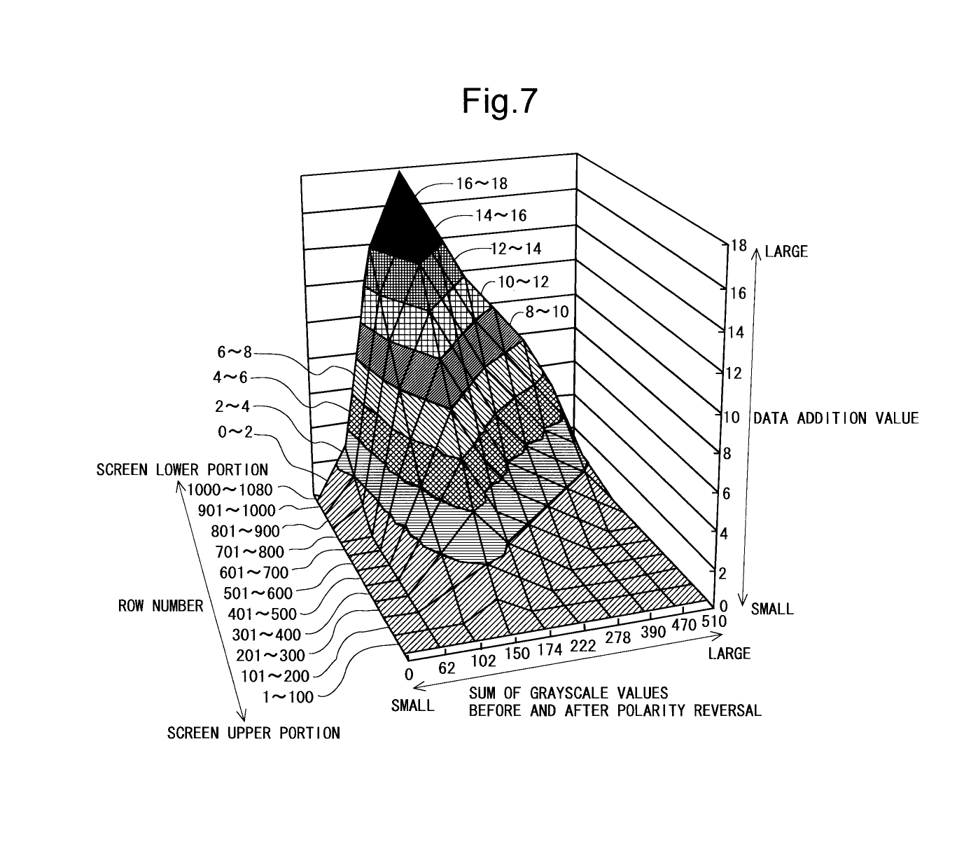

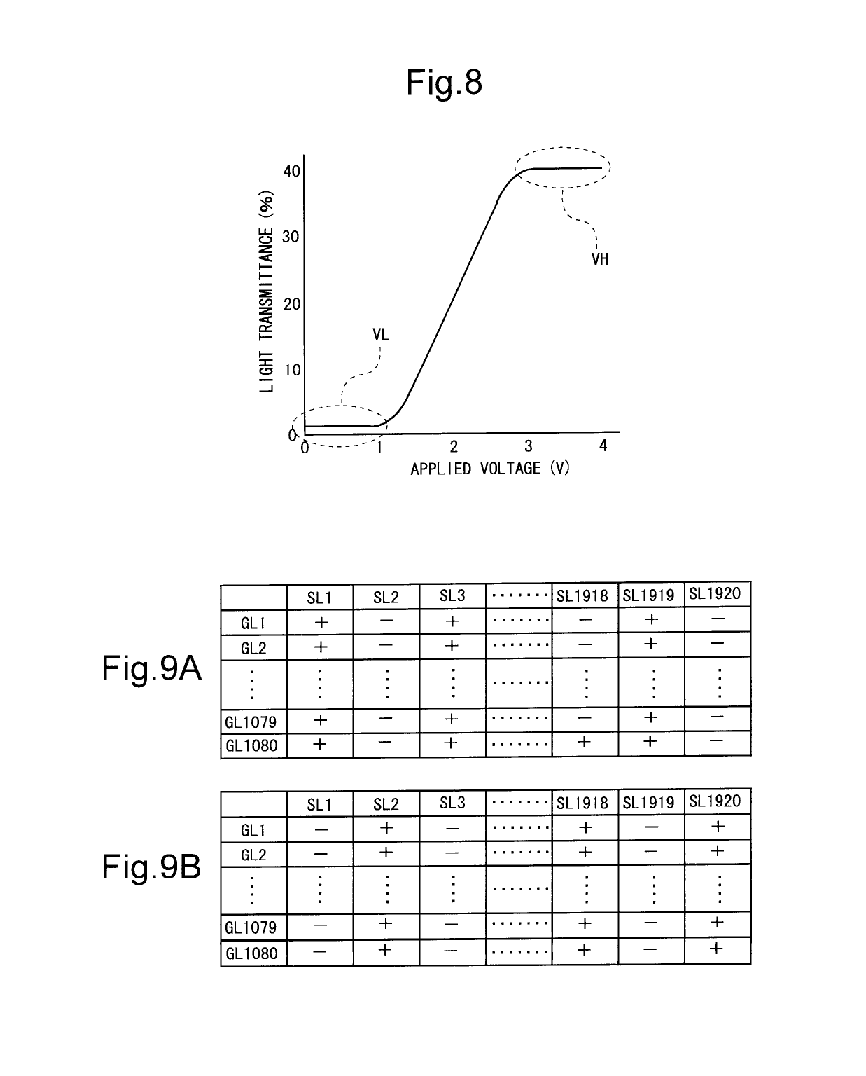

Data for determining the data addition value ΔKn is stored in the lookup table 212. FIG. 7 is a diagram schematically showing the data stored in the lookup table 212. Each data addition value ΔKn is determined by the sum of grayscale values for frames before and after polarity reversal is performed, and a row number (the number representing how many rows in a pixel matrix of 1080 rows×1920 columns there are before a given row). As shown in FIG. 7, when the sum of grayscale values immediately before and after polarity reversal has a constant value, the data addition value ΔKn increases from at the screen upper portion to at the screen lower portion. When the row number is constant, the data addition value ΔKn decreases as the sum of grayscale values immediately before and after polarity reversal approaches its minimum or maximum. The reason for this is because the transmittance characteristics of liquid crystal are as shown in FIG. 8, and thus, in the neighborhood of grayscale values relatively close to the maximum grayscale value and the minimum grayscale value, even if there is some change in grayscale value (i.e., even if there is some change in applied voltage), the light transmittance does not change almost at all as indicated by reference characters VH and VL in FIG. 8. On the other hand, in the neighborhood of a halftone value, since the change in light transmittance due to a change in grayscale value (i.e., a change in applied voltage) is great, the data addition value ΔKn also has a relatively large value. Note that FIG. 7 is an example and thus the values of data actually stored in the lookup table 212 are determined according to the characteristics, screen size, resolution, etc., of a display panel. Meanwhile, since data for obtaining data addition values is thus stored in the lookup table 212, a change to the data is easily made externally when necessary. When writing of data is sequentially performed row by row from at the screen lower portion to at the screen upper portion during each frame period, the data addition value Kn increases from at the screen lower portion to at the screen upper portion.

In the above-described manner, by the grayscale value adding unit 213 in the display interface circuit 210, data addition values ΔKn are obtained and the data addition values ΔKn are added to the grayscale values of an image to be displayed. Then, based on the values obtained after the addition, a digital video signal DV is generated. Since the source driver 300 applies voltages to the source bus lines SL1 to SL1920 based on the digital video signal DV, during a frame period immediately before reversal of the polarities of video signals is performed, voltages larger by voltage addition values ΔVn than video signal voltages originally supposed to be applied to the source bus lines SL1 to SL1920 are applied to the source bus lines SL1 to SL1920.

### 1.4 Effects

According to the present embodiment, in any frame period, the polarities of video signals applied to the respective source bus lines SL1 to SL1920 are maintained at either one of the positive polarity and the negative polarity. Namely, the polarities of video signals do not change (are not reversed) every horizontal scanning period. Hence, even if high-frequency driving is performed, sufficient time to charge the wiring capacitance of each of the source bus lines SL1 to SL1920 and the pixel capacitance of each pixel formation portion Pix is secured, and thus, the occurrence of display failure due to insufficient charging is prevented. In addition, according to the present embodiment, the polarities of video signals are reversed every three frame periods and during a frame period immediately before reversal of the polarities of video signals is performed, voltages corresponding to values obtained by adding data addition values ΔKn to the grayscale values of an image to be displayed are applied to the source bus lines SL1 to SL1920. Here, each data addition value ΔKn is determined based on the sum of grayscale values for frame periods immediately before and after reversal of the polarities of video signals is performed, and the row number. Hence, video signal voltages used when writing is performed for each row can be determined taking into account fluctuations in pixel electrode potential due to the presence of the parasitic capacitances 19 between the pixel electrodes 14 and the source bus lines SL1 to SL1920 and off-state leakage in the TFTs 10 in the pixel formation portions Pix. By this, the occurrence of flicker and luminance unevenness (display unevenness resulting from the difference in luminance between the screen upper portion and the screen lower portion) which conventionally occur when frame-reversal driving is adopted is suppressed. By the above, the display device can be driven at high frequencies without causing display failure due to insufficient charging, flicker, luminance unevenness, etc. Furthermore, according to the present embodiment, video signals of the same polarity are applied to the source bus lines SL1 to SL1920 from the source driver 300 for three continuous frame periods. Hence, the power consumption of the source driver 300 is reduced over a driving scheme where reversal of the polarities of video signals is performed every horizontal scanning period or every few horizontal scanning periods.

### 1.5 Variant, Etc.

In the above-described embodiment, the configuration is such that the frame memory 211, the lookup table 212, and the grayscale value adding unit 213 are included in the display interface circuit 210, and data addition values ΔKn are obtained in the display interface circuit 210. However, the configuration may be such that data addition values ΔKn are obtained in the input interface circuit 200 instead of the display interface circuit 210.

In addition, although in the above-described embodiment the polarities of video signals are reversed every three frame periods, the present invention is not limited thereto. The polarities of video signals may be reversed every two frame periods or may be reversed every plurality of frame periods which are four or more frames. Note that in general in the case of a driving frequency of 60 Hz, when reversal of the polarities of video signals is performed every 10 to 200 frame periods, flicker is likely to be visually recognized. Thus, it is preferable to perform polarity reversal every 240 frame or more periods. In addition, to prevent deterioration of liquid crystal, when the driving frequency is 60 Hz, it is preferable to perform polarity reversal every 6000 frame or less periods. Furthermore, it is preferable to determine the cycle of polarity reversal, taking also into account the driving frequency and the characteristics of the liquid crystal materials, etc.

Furthermore, although in the above-described embodiment the configuration is such that polarities such as those shown in FIG. 5A and polarities such as those shown in FIG. 5B alternately appear, the configuration may be such that polarities such as those shown in FIG. 9A and polarities such as those shown in FIG. 9B alternately appear. According to this configuration, the polarities of video signals for adjacent source bus lines differ from each other in any frame period, and thus, flicker is further less likely to be visually recognized.

### 2. Second Embodiment

### 2.1 Overall Configuration and Operation

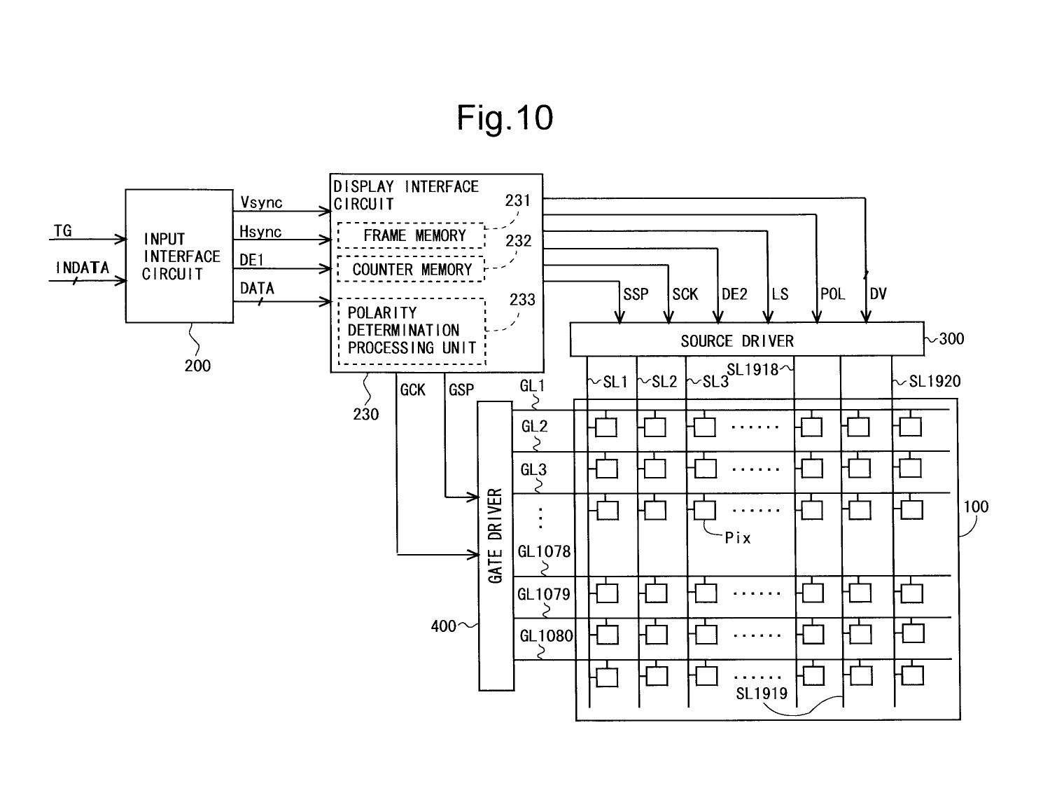

FIG. 10 is a block diagram showing an overall configuration of an active matrix-type liquid crystal display device according to a second embodiment of the present invention. The liquid crystal display device includes a display unit 100, an input interface circuit 200, a display interface circuit 230, a source driver (video signal line drive circuit) 300, and a gate driver (scanning signal line drive circuit) 400. The display interface circuit 230 includes a frame memory 231, a counter memory 232, and a polarity determining processing unit 233.

Note that, in the present embodiment, a driving control unit is implemented by the input interface circuit 200, the display interface circuit 230, the source driver 300, and the gate driver 400, a polarity difference holding unit is implemented by the counter memory 232, and a polarity determining unit is implemented by the polarity determination processing unit 233.

The polarity determination processing unit 233 determines the polarities of video signals for each frame, based on the APL of image data DATA for each frame, the magnitude of change in APL between frames, and the past polarities of the video signals. As used herein, the “APL” refers to an average luminance level (Average Picture Level) of image data DATA for one frame. Note that a process performed by the polarity determination processing unit 233 is hereinafter referred to as a “polarity determination process”. In the frame memory 231 is stored image data DATA for two consecutive frames. In the counter memory 232 is stored the value of a variable CNT used in a polarity determination process which will be described later. Other configurations than the above are the same as those in the above-described first embodiment and thus description thereof is omitted.

As described above, in the present embodiment, the polarities of video signals for each frame are determined by the polarity determination processing unit 233 in the display interface circuit 230. Then, based on the polarities determined by the polarity determination processing unit 233, a polarity instruction signal POL indicating the polarities of the video signals is sent to the source driver 300 from the display interface circuit 230. Note that, as in the first embodiment, when taking a look at a given source bus line, the polarity of a video signal is maintained at either one of the positive polarity and the negative polarity throughout one frame period. Specifically, when taking a look at the entire screen in any frame, “polarities such as those shown in FIG. 5A or polarities such as those shown in FIG. 5B appear” or “polarities such as those shown in FIG. 9A or polarities such as those shown in FIG. 9B appear”.

### 2.2 Polarity Determination Process

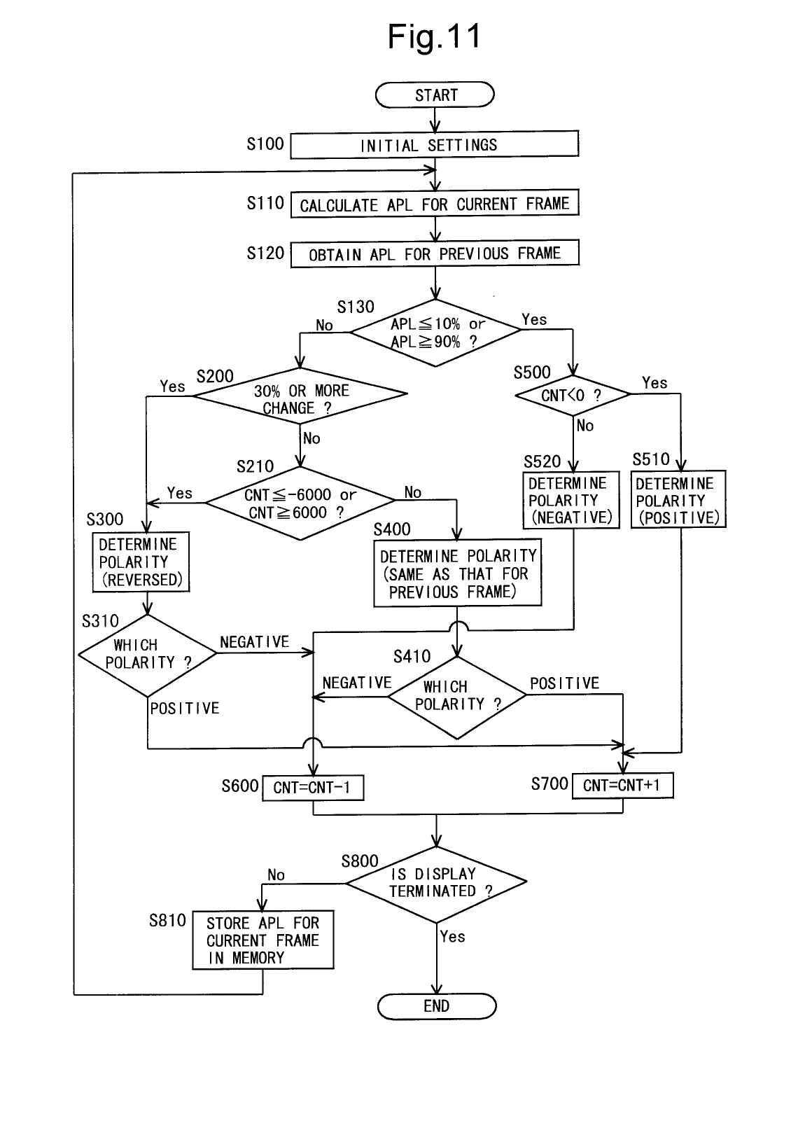

Next, a method for determining the polarities of video signals in the present embodiment will be described. FIG. 11 is a flowchart showing the procedural steps of a polarity determination process. The polarity determination process uses a variable CNT. The variable CNT stores a difference between the number of occurrences of a positive polarity and the number of occurrences of a negative polarity (hereinafter, simply referred to as a “polarity difference”) for the polarities of video signals for each frame after the start of the operation of the liquid crystal display device. To do so, in the polarity determination process, for every frame, if the polarities of the video signals are positive then 1 is added to the variable CNT, and if the polarities of video signals are negative then 1 is subtracted from the variable CNT. For example, when, at the point in time when display for 10 frames has been performed after the start of the operation of the liquid crystal display device, “three frames have positive polarities and seven frames have negative polarities”, the value of the variable CNT at that point in time is “−4”. When, at the point in time when display for 30 frames has been performed after the start of the operation of the liquid crystal display device, “21 frames have positive polarities and 9 frames have negative polarities”, the value of the variable CNT at that point in time is “12”. As described above, by the value of the variable CNT, how many more/less positive polarity frames there are than negative polarity frames is grasped. Note that in the case of a configuration in which video signals of different polarities are applied to adjacent source bus lines (a configuration where “polarities such as those shown in FIG. 9A or polarities such as those shown in FIG. 9B appear”), it is preferable to determine the polarity of either one of the odd-numbered columns and the even-numbered columns by this polarity determination process and to set the other polarity to the opposite polarity to the polarity determined by the polarity determination process.

The procedural steps of a polarity determination process will be described below. After the start of the operation of the display device, the polarity determination processing unit 233 first performs initial settings (step S100). In the initial settings, for example, settings such as “CNT=0”, “polarity=positive”, and “APL for the previous frame=50%” are performed. After the completion of the initial settings, the polarity determination processing unit 233 calculates an APL of image data DATA for the current frame (step S110). Then, the polarity determining processing unit 233 obtains an APL of image data DATA for the previous frame from the memory (step S120). Thereafter, the polarity determination processing unit 233 determines whether the APL for the current frame is “10% (second threshold value) or less, or 90% (third threshold value) or more” (step S130). If, as a result of the determination, the APL for the current frame is “10% or less, or 90% or more”, then processing proceeds to step S500, or otherwise proceeds to step S200.

When processing proceeds to step S500, a process for reducing a polarity difference is performed as follows. The polarity determination processing unit 233 determines whether the value of the variable CNT is less than 0 (step S500). If, as a result of the determination, the value of the variable CNT is less than 0, then processing proceeds to step S510, or otherwise proceeds to step S520. In step S510, the polarity determination processing unit 233 determines the polarity for the current frame to be a positive polarity. Then, in step S700, the polarity determination processing unit 233 adds “1” to the variable CNT. In step S520, the polarity determination processing unit 233 determines the polarity for the current frame to be a negative polarity. Then, in step S600, the polarity determination processing unit 233 subtracts “1” from the variable CNT. In the above-described manner, when the number of occurrences of a negative polarity is greater than the number of occurrences of a positive polarity up to the current point in time, the polarity for the current frame is set to a positive polarity, and when the number of occurrences of a positive polarity is greater than the number of occurrences of a negative polarity up to the current point in time, the polarity for the current frame is set to a negative polarity. Note that the reason that, when the APL is “10% or less, or 90% or more”, the polarity for the current frame is determined based on a polarity difference is because when an overall extremely bright image is displayed or when an overall extremely dark image is displayed, even if polarity reversal is performed, flicker is less likely to be visually recognized.

In step S200, the polarity determination processing unit 233 compares the APL for the current frame with the APL for the previous frame to determine whether there is a 30% (first threshold value) or more change. If, as a result of the determination, there is a 30% or more change, then processing proceeds to step S300, or otherwise proceeds to step S210. In step S210, the polarity determination processing unit 233 determines whether the value of the variable CNT is “−6000 or less, or 6000 (fourth threshold value) or more”. If, as a result of the determination, the value of the variable CNT is “−6000 or less, or 6000 or more”, then processing proceeds to step S300, or otherwise proceeds to step S400.

In step S300, the polarity determination processing unit 233 determines the polarity for the current frame to be a “polarity obtained by reversing the polarity for the previous frame”. Thereafter, the polarity determination processing unit 233 determines whether the polarity determined in step S300 is a positive polarity or a negative polarity. If, as a result of the determination, the polarity is a positive polarity, then processing proceeds to step S700 and “1” is added to the variable CNT. On the other hand, if the polarity is a negative polarity, then processing proceeds to step S600 and “1” is subtracted from the variable CNT. Note that the reason that polarity reversal is performed when the APL is changed by 30% or more is because the time when the APL changes greatly is generally the timing of switching of scenes and even if polarity reversal is performed at such a timing, flicker is less likely to be visually recognized. In addition, the reason that polarity reversal is performed when the value of the variable CNT is “−6000 or less, or 6000 or more” is to prevent deterioration of liquid crystal due to a bias in polarity occurring when still image display is performed.

In step S400, the polarity determination processing unit 233 determines the polarity for the current frame to be the “same polarity as that for the previous frame”. Thereafter, the polarity determination processing unit 233 determines whether the polarity determined in step S400 is a positive polarity or a negative polarity. If, as a result of the determination, the polarity is a positive polarity, then processing proceeds to step S700 and “1” is added to the variable CNT. On the other hand, if the polarity is a negative polarity, then processing proceeds to step S600 and “1” is subtracted from the variable CNT.

After the completion of step S600 or S700, processing proceeds to step S800 and the polarity determination processing unit 233 determines whether the display is terminated or not (e.g., whether a power-off instruction is provided, etc.). If, as a result of the determination, the display is terminated, then the polarity determination process ends. On the other hand, if the display is not terminated, then the polarity determination processing unit 233 stores the APL for the current frame calculated in step S110 in the memory (step S810). Note that the APL stored in the memory in step S810 is obtained by the polarity determination processing unit 233 as the “APL for the previous frame” when a process in step S120 is performed next time. After the completion of step S810, processing returns to the step S110. Then, processes in and after step S110 are repeated until the display is terminated (until determined “Yes” in step S800).

Meanwhile, the numerical values which are comparison targets in the above-described steps S130, S200, and S210 are examples and thus it is preferable to adopt appropriate numerical values according to a liquid crystal material, a pixel structure, panel size, driving frequency, etc. Although the above description uses the terms “current frame” and “previous frame”, in practice, image display is performed after polarity determination and thus a process is performed with one frame delay (during a period during which a process for determining the polarity for the current frame is performed, an image for the previous frame is displayed).

Note that, in the present embodiment, a first polarity determining unit (step) is implemented by steps S200 and S300, a second polarity determining unit (step) is implemented by steps S130, S500, S510, and S520, and a third polarity determining unit (step) is implemented by steps S210 and S300.

### 2.3 Effects

According to the present embodiment, as in the above-described first embodiment, the polarities of video signals for respective source bus lines SL1 to SL1920 are maintained at either one of the positive polarity and the negative polarity. Hence, even if high-frequency driving is performed, sufficient time to charge the wiring capacitance of each of the source bus lines SL1 to SL1920 and the pixel capacitance of each pixel formation portion Pix is secured, and thus, the occurrence of display failure due to insufficient charging is prevented. In addition, according to the present embodiment, reversal of the polarities of video signals is performed when scenes are switched or when an overall extremely bright image or an overall extremely dark image is displayed. Hence, even if reversal of the polarities of video signals is performed, flicker is less likely to be visually recognized. In addition, by employing a configuration in which the polarities of video signals for adjacent source bus lines differ from each other (see FIGS. 9A and 9B), flicker is further less likely to be visually recognized. Furthermore, according to the present embodiment, for a frame in which display of an overall extremely bright image or an overall extremely dark image is performed, the polarities of video signals are determined so as to reduce a polarity difference. Hence, a bias in the polarity for voltages applied to the liquid crystal is reduced and thus deterioration of the liquid crystal is suppressed. Furthermore, when still image display is performed, too, reversal of the polarities of video signals is performed whenever necessary, and thus, deterioration of the liquid crystal is suppressed.

### 2.4 Variant

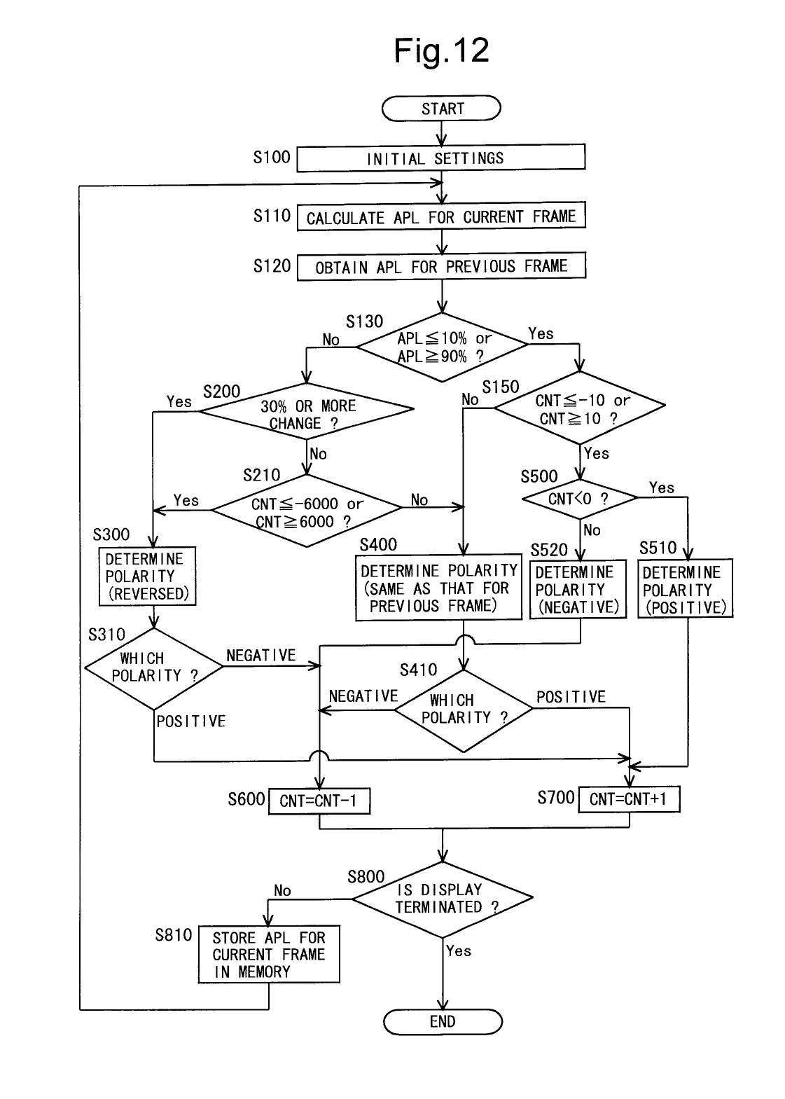

A variant of the above-described second embodiment will be described. FIG. 12 is a flowchart showing the procedural steps of a polarity determination process in a variant of the second embodiment. In the variant, a process in step S150 which will be described below is performed between step S130 and step S500.

In step S150, the polarity determination processing unit 233 determines whether the value of the variant CNT is “−10 or less, or 10 or more”. If, as a result of the determination, the value of the variable CNT is “−10 or less, or 10 or more”, then processing proceeds to step S500, or otherwise proceeds to step S400. Processes at other steps are the same as those in the second embodiment and thus description thereof is omitted.

Next, effects brought about by the variant will be described. According to the second embodiment, when there are consecutive frames in which the “APL is 10% or less, or 90% or more”, the values of the variable CNT, “−1” and “0”, may be alternately and continuously repeated. Specifically, the determination results in step S500, “Yes” and “No”, may be alternately and continuously repeated. In such a case, reversal of the polarities of video signals is performed every frame. On the other hand, in the variant, before step S500, it is determined instep S150 whether the value of the variable CNT is “−10 or less, or 10 or more”. Then, if, as a result of the determination, the value of the variable CNT is not “−10 or less, or 10 or more”, processing proceeds to step S400 and the polarity for the current frame is set to the same polarity as that for the previous frame. This prevents “performing of reversal of the polarities of video signals every frame”, and thus, the power consumption of the source driver 300 is reduced. Note that although in the variant, in step S150, the value of the variable CNT is compared with “−10” and “10”, this is an example and thus the value of the variable CNT may be compared with other values than “−10” and “10”.

### 2.5 Others

Although, in the above-described second embodiment and variant, description is made based on the premise that in step S100 an initial setting is performed on the value of the variable CNT (e.g., a setting of “CNT=0”), the present invention is not limited thereto. When the configuration is such that the value of the variable CNT is stored in a “nonvolatile memory”, instead of a polarity difference obtained after every activation of the liquid crystal display device, a polarity difference obtained after shipment of the liquid crystal display device is reflected in the value of the variable CNT. Thus, deterioration of the liquid crystal is more effectively suppressed.

In addition, although, in the above-described second embodiment and variant, a determination of the polarities of video signals is made based on the APL of image data DATA for each frame, the present invention is not limited thereto. A determination of the polarities of video signals may be made based on a histogram representing the distribution of the luminances of image data DATA for each frame.

### 3. Reference Example

Next, another exemplary configuration for preventing the occurrence of flicker and luminance unevenness (display unevenness resulting from the difference in luminance between the screen upper portion and the screen lower portion) which conventionally occur when frame-reversal driving is adopted will be described below as a reference example.

### 3.1 Configuration

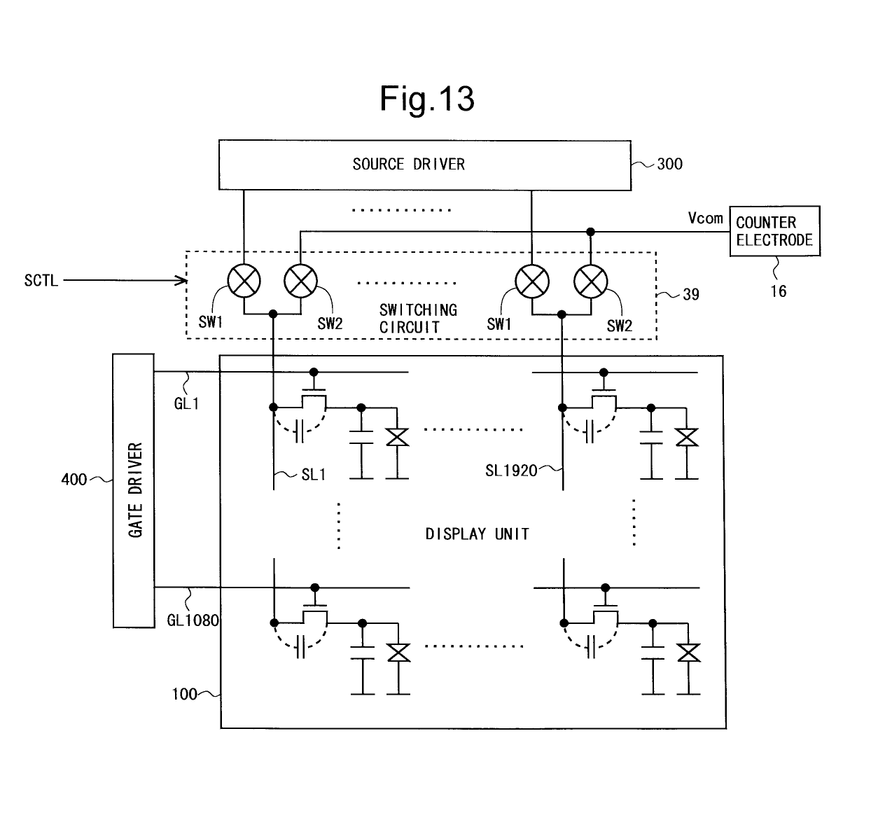

FIG. 13 is a block diagram showing a configuration of a main part of a liquid crystal display device according to the reference example. The liquid crystal display device employs a normally black mode as a display mode. As shown in FIG. 13, the liquid crystal display device is provided with a switching circuit 39 for switching a potential to be provided to each of source bus lines SL1 to SL1920 between a potential of a video signal outputted from a source driver 300 and a potential Vcom of a counter electrode 16. The switching circuit 39 includes switches SW1 each for controlling an electrical connection between the source driver 300 and a corresponding one of the source bus lines SL1 to SL1920; and switches SW2 each for controlling an electrical connection between the counter electrode 16 and a corresponding one of the source bus lines SL1 to SL1920. The on and off of the switches SW1 and SW2 are controlled by, for example, a control signal SCTL sent from a display interface circuit 210. Note that the configuration may be such that the switches SW1 and SW2 are included in the source driver 300. Alternatively, the configuration may be such that the source driver 300 and agate driver 400 are provided on both sides of a display unit 100.

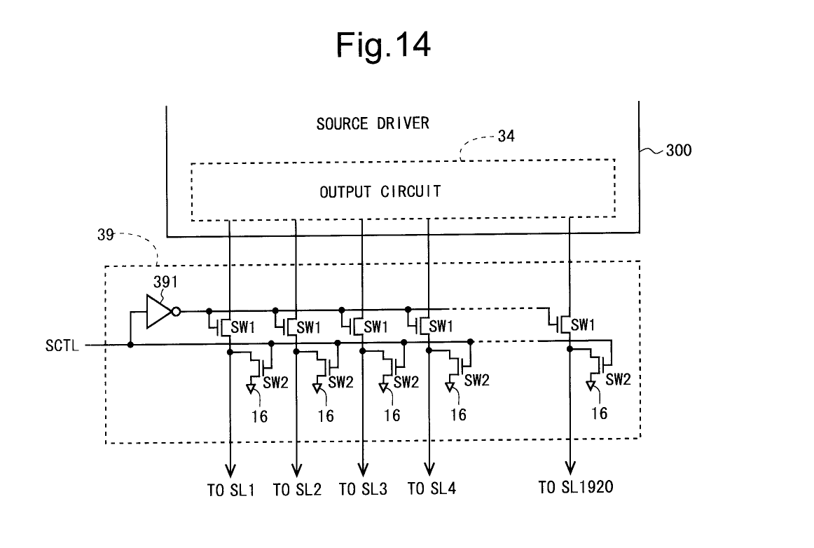

FIG. 14 is a circuit diagram showing a detailed exemplary configuration of the switching circuit 39. As shown in FIG. 14, the switching circuit 39 includes the switches SW1, each of which connects an output circuit 34 in the source driver 300 to a corresponding one of the source bus lines SL1 to SL1920; the switches SW2, each of which connects the counter electrode 16 to a corresponding one of the source bus lines SL1 to SL1920; and an inverter 391 that outputs a logic inverted signal of a control signal SCTL. The switches SW1 and SW2 are formed of, for example, MOS transistors. An output signal from the inverter 391, i.e., a logic inverted signal of a control signal SCTL, is provided to gate terminals of the respective switches SW1, and the control signal SCTL is provided to gate terminals of the respective switches SW2. By a configuration such as that described above, when the control signal SCTL is active (the logic level is a high level), the switches SW1 are placed in an off state and the switches SW2 are placed in an on state. By this, the potential Vcom of the counter electrode 16 is provided to the source bus lines SL1 to SL1920. On the other hand, when the control signal SCTL is non-active (the logic level is a low level), the switches SW1 are placed in an on state and the switches SW2 are placed in an off state. By this, the potentials of video signals outputted from the source driver 300 are provided to the source bus lines SL1 to SL1920.

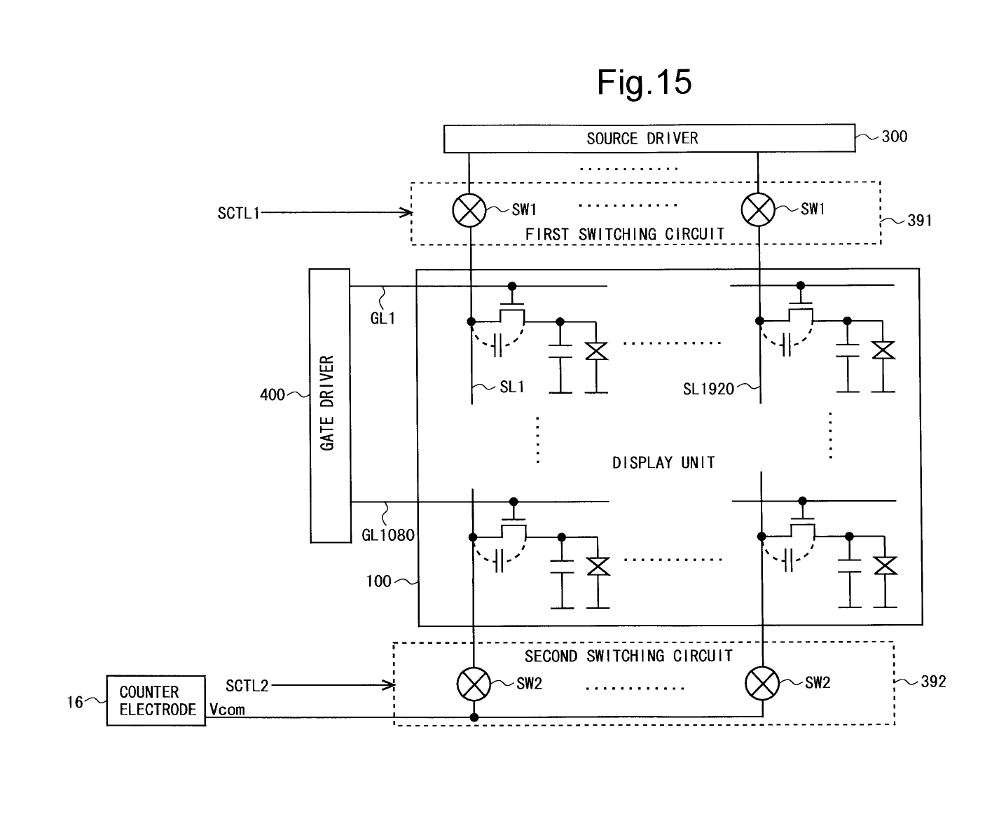

Note that instead of the configuration shown in FIG. 13, the configuration may be such that, as shown in FIG. 15, a first switching circuit 391 including switches SW1 each for controlling an electrical connection between a source driver 300 and a corresponding one of source bus lines SL1 to SL1920 is provided on a side on which the source driver 300 is disposed with reference to a display unit 100, and a second switching circuit 392 including switches SW2 each for controlling an electrical connection between a counter electrode 16 and a corresponding one of the source bus lines SL1 to SL1920 is provided on the opposite side of the side on which the source driver 300 is disposed with reference to the display unit 100.

In the case of this configuration, a first control signal SCTL1 and a second control signal SCTL2 whose logic levels are opposite to each other are provided to the first switching circuit 391 and the second switching circuit 392, respectively.

### 3.2 Driving Method

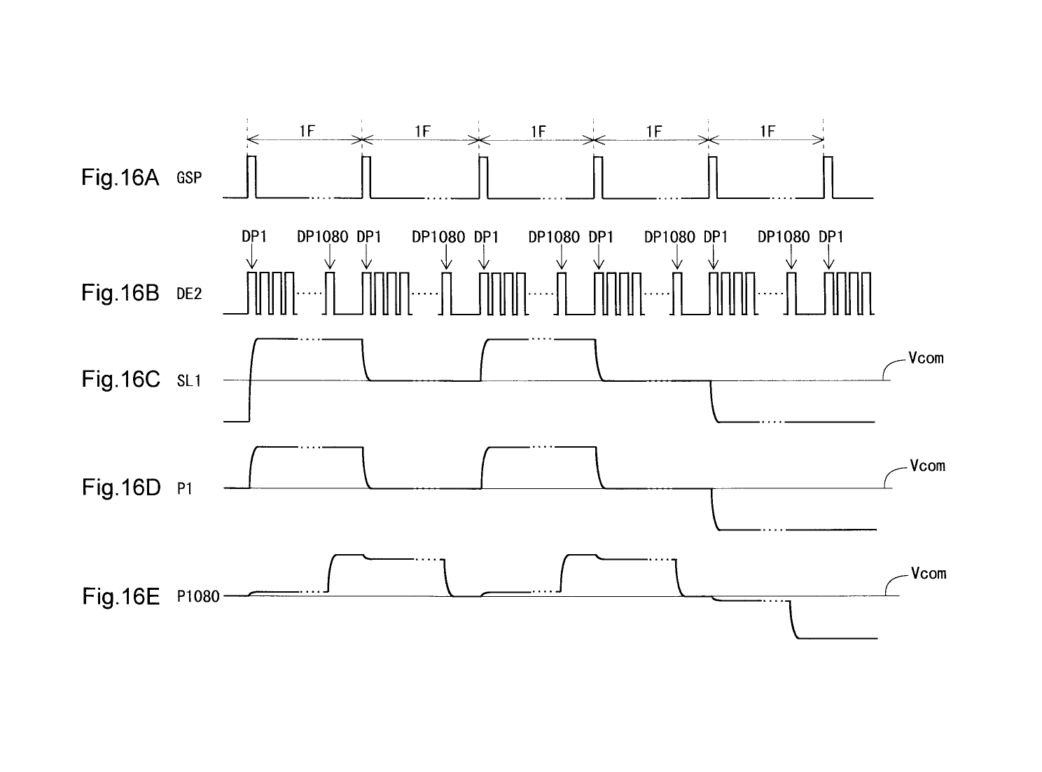

A driving method in the reference example will be described with reference to FIGS. 16A to 16E. In the reference example, as shown in FIG. 16C, a potential Vcom of the counter electrode 16 is provided to the source bus lines SL1 to SL1920 every other frame. By this, during the operation of the liquid crystal display device, a frame in which black display is performed (hereinafter, referred to as a “black frame”) is inserted every other frame. Excluding the black frames, reversal of the polarities of video signals is performed every two frame periods. Note that such insertion of black frames is performed by switching on and off of the switches SW1 and SW2 in the above-described switching circuit 39.

### 3.3 Effects

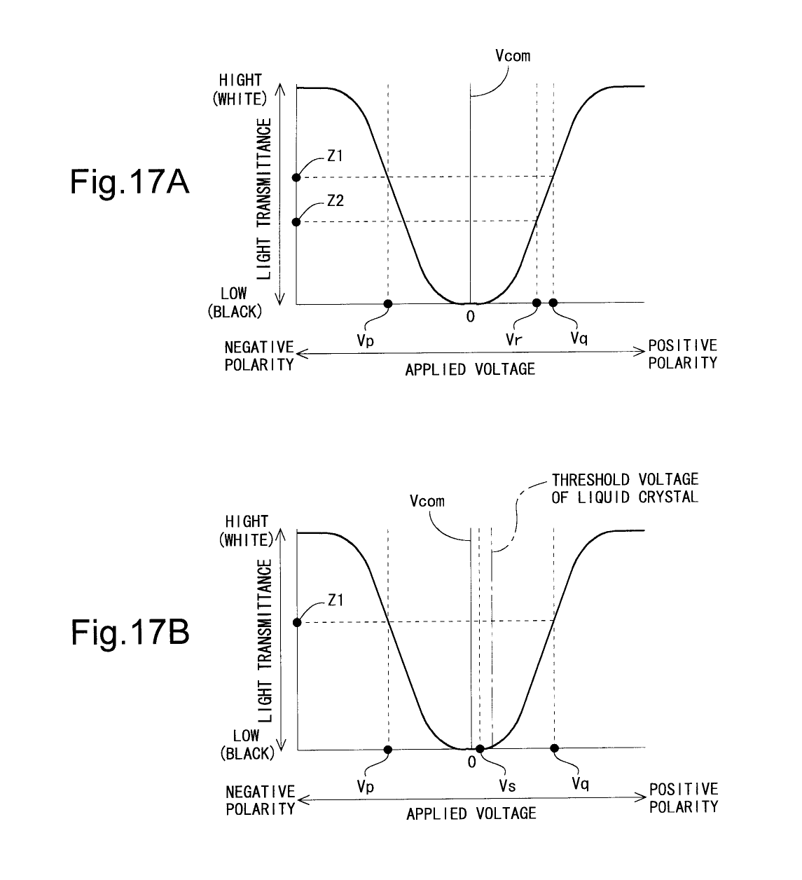

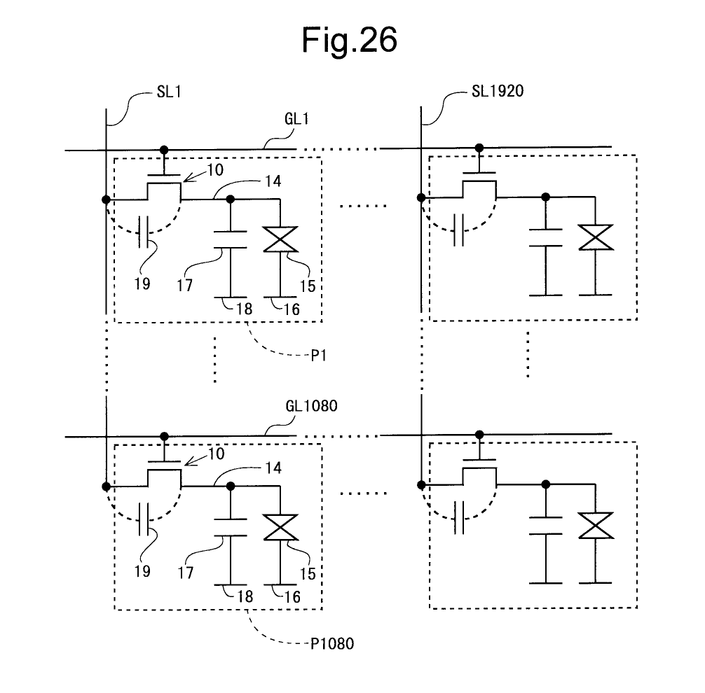

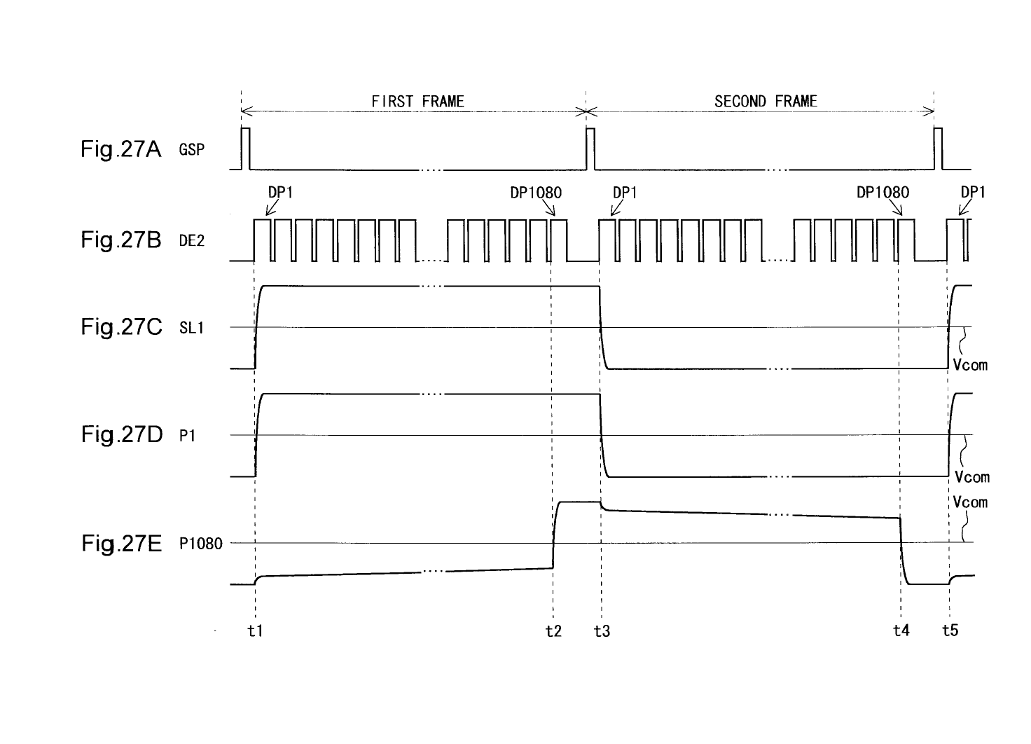

Effects brought about by the reference example will be described. FIGS. 17A and 17B each show the transmittance characteristics of liquid crystal. The operation by conventional frame-reversal driving will be described with reference to FIG. 17A and the operation in the reference example will be described with reference to FIG. 17B. Here, the operation will be described where writing of a desired positive polarity voltage Vq is performed in a state in which a given negative polarity voltage Vp is written in pixel formation portions P1080 (see FIG. 26). Note that in FIGS. 17A and 17B, the horizontal axis represents applied voltage to the liquid crystal and the vertical axis represents the light transmittance of the liquid crystal.

According to the conventional example, when, in a state in which a negative polarity voltage Vq is written, writing of a desired positive polarity voltage Vp is performed from pixel formation portions P1 to obtain a desired light transmittance

Z1, due to the presence of parasitic capacitances 19 between pixel electrodes 14 and source bus lines SL (see FIG. 19) and the occurrence of off-state leakage in TFTs 10, the potentials of the pixel electrodes 14 are pulled to the potential Vcom side of the counter electrode 16. Hence, the effective value of an applied voltage to the liquid crystal in the pixel formation portions P1080 is a voltage Vr which is smaller than the desired voltage Vq. As a result, a light transmittance Z2 smaller than the desired light transmittance Z1 is obtained and accordingly an image darker than an image originally supposed to be displayed is displayed. When writing of a desired negative polarity voltage is performed in a state in which a given positive polarity voltage is written, too, likewise, an image darker than an image originally supposed to be displayed is displayed.

On the other hand, according to the reference example, before writing of an opposite polarity voltage is performed, the potential Vcom of the counter electrode 16 is provided to the source bus lines and thus an applied voltage to the liquid crystal is zero. Thereafter, by applying positive or negative polarity video signals to the source bus lines to write to the first row, pulling of the potentials of pixel electrodes 14 (pulling to the potential side of the source bus lines) occurs in the pixel formation portions P1080. However, even if the difference between the potentials of the pixel electrodes 14 in the pixel formation portions P1080 and the potentials of the source bus lines is maximum, it is one-half of the amplitudes of the video signals, and thus, the magnitude of the pulling is less than or equal to the threshold voltage of the liquid crystal. Thereafter, in the pixel formation portions P1080, writing of a desired voltage is performed, thereby obtaining a desired transmittance.

As described above, according to the reference example, a black frame is inserted every other frame during the operation of the liquid crystal display device. Hence, upon switching the polarities of video signals, the potentials of the pixel electrodes 14 in the respective pixel formation portions Pix are not greatly pulled to the potential side of their corresponding source bus lines SL1 to SL1920. This prevents the occurrence of display unevenness resulting from the difference in luminance between the screen upper portion and the screen lower portion. In addition, when reversal of the polarities of video signals is performed every plurality of frame periods, the frequency of a flicker component becomes relatively low and thus flicker is likely to be visually recognized. However, in the reference example, since a black frame is inserted every other frame, the frequency of a flicker component is increased and thus flicker is less likely to be visually recognized. In addition, by turning off a backlight during black frame periods, power consumption can also be reduced.

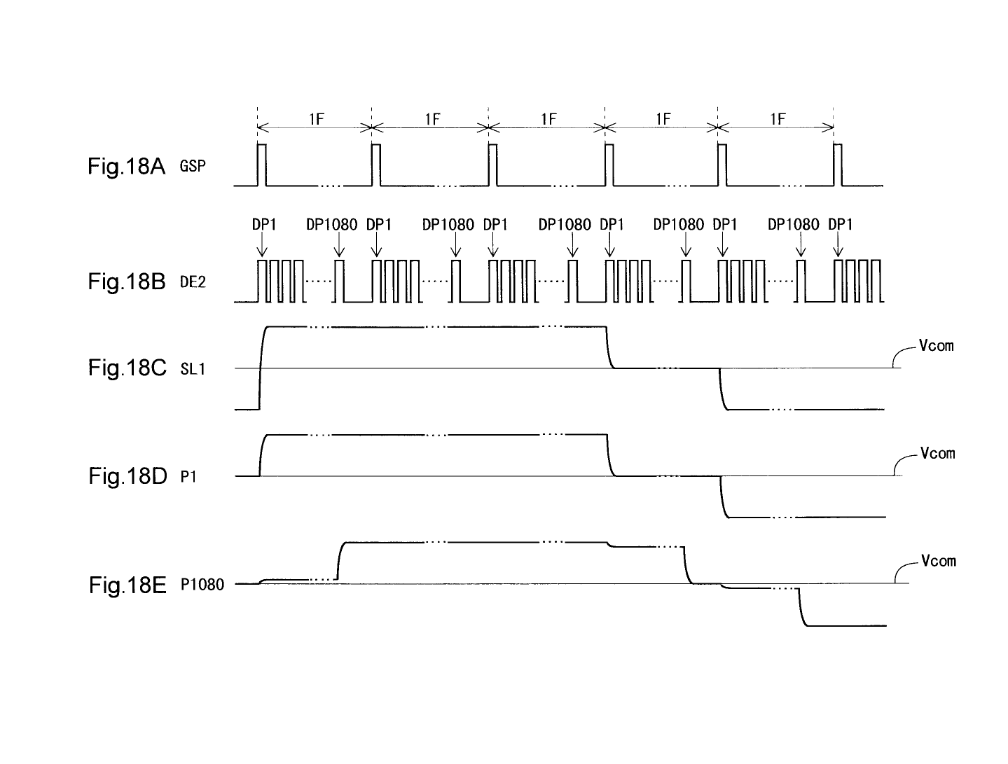

Note that, as shown in FIG. 18, instead of a configuration in which a black frame is inserted every other frame, the configuration may be such that a black frame is inserted only when reversal of the polarities of video signals is performed.

According to this configuration, since fluctuations in the potentials of the source bus lines SL1 to SL1920 decrease, power consumption is reduced. Note, however, that taking into account flicker, it is preferable to adopt this configuration typically when reversal of the polarities of video signals is performed every 3 to 10 frames. Also, the configuration may be such that a black frame is inserted every plurality of frame periods. For example, the configuration may be such that “reversal of the polarities of video signals is performed every 240 frame periods and a black frame is inserted every 3 to 10 frame periods”.

The reference example can also be applied to a liquid crystal display device adopting a normally white mode, by providing the device with a power supply that supplies a potential corresponding to black.

1. A liquid crystal display device comprising: a plurality of video signal lines for transmitting a plurality of video signals being based on an image signal sent from an external source; a plurality of scanning signal lines intersecting with the plurality of video signal lines; a plurality of pixel formation portions arranged in a matrix form at respective intersection of the plurality of video signal lines and the plurality of scanning signal lines; and a driving control unit for driving the plurality of video signal lines and selectively driving the plurality of scanning signal lines, wherein
each pixel formation portion includes a pixel capacitance that is charged with a voltage of a video signal which is transmitted through a video signal line passing through a corresponding intersection when a scanning signal line passing through the corresponding intersection is selected,
the driving control unit includes:
a polarity determining unit that determines polarities of the plurality of video signals such that a polarity of a video signal applied to each video signal line is reversed every plurality of frames; and
a video signal line drive circuit that applies, as the video signal, a grayscale voltage among a plurality of grayscale voltages associated in advance with a plurality of displayable grayscale values for each of a positive polarity and a negative polarity, to each video signal line, the grayscale voltage being associated with a combination of a grayscale value of the image signal and a polarity determined by the polarity determining unit, and
during a period of a first frame, a grayscale voltage applied to each video signal line as the video signal is increased according to a selected scanning signal line, the first frame being a frame immediately before the polarities of the plurality of video signals are reversed.

2. The liquid crystal display device according to claim 1, wherein the driving control unit further includes a grayscale value adding unit that adds a data addition value to a grayscale value of the image signal for the first frame among grayscale values for determining grayscale voltages to be applied to the respective video signal lines as the video signals when each scanning signal line is selected, the data addition value being determined based on grayscale values of the image signal for the first frame and a second frame and an order in which the scanning signal line is selected in the second frame, and the second frame being a next frame to the first frame.

3. The liquid crystal display device according to claim 2, wherein when a sum of the grayscale value of the image signal for the first frame and the grayscale value of the image signal for the second frame is constant, the grayscale value adding unit increases the value of the data addition value as an order in which the scanning signal lines are selected gets later.

4. The liquid crystal display device according to claim 2, wherein when an order in which the scanning signal lines are selected is constant, the grayscale value adding unit decreases the value of the data addition value as a sum of the grayscale value of the image signal for the first frame and the grayscale value of the image signal for the second frame approaches a maximum value or a minimum value that the sum can take.

5. The liquid crystal display device according to claim 2, wherein
the driving control unit further includes a lookup table in which a combination of a sum of the grayscale values of the image signal for the first frame and the second frame and an order in which the scanning signal lines are selected is associated with the data addition value, and
the grayscale value adding unit obtains the data addition value from the lookup table.

6. The liquid crystal display device according to claim 1, wherein the video signal line drive circuit applies video signals of different polarities to adjacent video signal lines during a period of each frame.

7. A liquid crystal display device comprising: a plurality of video signal lines for transmitting a plurality of video signals being based on an image signal sent from an external source; a plurality of scanning signal lines intersecting with the plurality of video signal lines; a plurality of pixel formation portions arranged in a matrix form at respective intersection of the plurality of video signal lines and the plurality of scanning signal lines; and a driving control unit for driving the plurality of video signal lines and selectively driving the plurality of scanning signal lines, wherein
each pixel formation portion includes a pixel capacitance that is charged with a voltage of a video signal which is transmitted through a video signal line passing through a corresponding intersection when a scanning signal line passing through the corresponding intersection is selected,
the driving control unit includes:
a polarity determining unit that determines, based on luminance data obtained from the image signal for a first frame and a second frame, a polarity of a video signal to be applied to each video signal line during a period of the second frame, the first and second frames being any two consecutive frames and the second frame being a subsequent frame of the two frames; and
a video signal line drive circuit that applies, during a period of each frame, a video signal of a polarity determined by the polarity determining unit to each video signal line without changing the polarity, and
the polarity determining unit includes a first polarity determining unit that determines, if there is a difference of a predetermined magnitude or more between the luminance data for the first frame and the luminance data for the second frame, the polarity of the video signal to be applied to each video signal line during the period of the second frame to be an opposite polarity to a polarity of a video signal applied to the video signal line during a period of the first frame.

8. The liquid crystal display device according to claim 7, wherein
the polarity determining unit further includes an average luminance calculating unit that calculates an average luminance level of the image signal for each frame as the luminance data, and
the first polarity determining unit determines, if there is a difference of a predetermined first threshold value or more between the average luminance level for the first frame and the average luminance level for the second frame, the polarity of the video signal to be applied to each video signal line during the period of the second frame to be an opposite polarity to a polarity of a video signal applied to the video signal line during the period of the first frame.

9. The liquid crystal display device according to claim 8, wherein the first threshold value is set to any value between 20% and 40%, inclusive.

10. The liquid crystal display device according to claim 8, further comprising a polarity difference holding unit that holds, as a polarity difference, a difference between a number of occurrences of a positive polarity and a number of occurrences of a negative polarity, based on the polarities determined by the polarity determining unit, wherein
the polarity determining unit further includes a second polarity determining unit that determines, if the average luminance level for the second frame is less than or equal to a predetermined second threshold value or greater than or equal to a predetermined third threshold value, the polarity of the video signal to be applied to each video signal line during the period of the second frame to be a polarity whose number of occurrences is lesser, based on the polarity difference.

11. The liquid crystal display device according to claim 10, wherein
the second threshold value is set to any value between 0% and 10%, inclusive and
the third threshold value is set to any value between 90% and 100%, inclusive.

12. The liquid crystal display device according to claim 10, wherein the polarity determining unit further includes a third polarity determining unit that determines, if the polarity difference is greater than or equal to a predetermined fourth threshold value, the polarity of the video signal to be applied to each video signal line during the period of the second frame to be an opposite polarity to a polarity of a video signal applied to the video signal line during the period of the first frame.

13. The liquid crystal display device according to claim 7, wherein the video signal line drive circuit applies video signals of different polarities to adjacent video signal lines during a period of each frame.

14. A method for driving a liquid crystal display device including: a plurality of video signal lines for transmitting a plurality of video signals being based on an image signal sent from an external source; a plurality of scanning signal lines intersecting with the plurality of video signal lines; and a plurality of pixel formation portions arranged in a matrix form at respective intersection of the plurality of video signal lines and the plurality of scanning signal lines, the driving method comprising:
a driving control step of driving the plurality of video signal lines and selectively driving the plurality of scanning signal lines, wherein
each pixel formation portion includes a pixel capacitance that is charged with a voltage of a video signal which is transmitted through a video signal line passing through a corresponding intersection when a scanning signal line passing through the corresponding intersection is selected,
the driving control step includes:
a polarity determining step of determining polarities of the plurality of video signals such that a polarity of a video signal applied to each video signal line is reversed every plurality of frames; and
a video signal line driving step of applying, as the video signal, a grayscale voltage among a plurality of grayscale voltages associated in advance with a plurality of displayable grayscale values for each of a positive polarity and a negative polarity, to each video signal line, the grayscale voltage being associated with a combination of a grayscale value of the image signal and a polarity determined in the polarity determining step, and
during a period of a first frame, a grayscale voltage applied to each video signal line as the video signal is increased according to a selected scanning signal line, the first frame being a frame immediately before the polarities of the plurality of video signals are reversed.

15. The driving method according to claim 14, wherein the driving control step further includes a grayscale value adding step of adding a data addition value to a grayscale value of the image signal for the first frame among grayscale values for determining grayscale voltages to be applied to the respective video signal lines as the video signals when each scanning signal line is selected, the data addition value being determined based on grayscale values of the image signal for the first frame and a second frame and an order in which the scanning signal line is selected in the second frame, and the second frame being a next frame to the first frame.

16. The driving method according to claim 15, wherein in the grayscale value adding step, when a sum of the grayscale value of the image signal for the first frame and the grayscale value of the image signal for the second frame is constant, the value of the data addition value is increased as an order in which the scanning signal lines are selected gets later.

17. The driving method according to claim 15, wherein in the grayscale value adding step, when an order in which the scanning signal lines are selected is constant, the value of the data addition value decreases as a sum of the grayscale value of the image signal for the first frame and the grayscale value of the image signal for the second frame approaches a maximum value or a minimum value that the sum can take.

18. The driving method according to claim 15, wherein
the liquid crystal display device further includes a lookup table in which a combination of a sum of the grayscale values of the image signal for the first frame and the second frame and an order in which the scanning signal lines are selected is associated with the data addition value, and
in the grayscale value adding step, the data addition value is obtained from the lookup table.

19. The driving method according to claim 14, wherein in the video signal line driving step, video signals of different polarities are applied to adjacent video signal lines during a period of each frame.

20. A method for driving a liquid crystal display device including: a plurality of video signal lines for transmitting a plurality of video signals being based on an image signal sent from an external source; a plurality of scanning signal lines intersecting with the plurality of video signal lines; and a plurality of pixel formation portions arranged in a matrix form at respective intersection of the plurality of video signal lines and the plurality of scanning signal lines, the driving method comprising:
a driving control step of driving the plurality of video signal lines and selectively driving the plurality of scanning signal lines, wherein
each pixel formation portion includes a pixel capacitance that is charged with a voltage of a video signal which is transmitted through a video signal line passing through a corresponding intersection when a scanning signal line passing through the corresponding intersection is selected,
the driving control step includes:
a polarity determining step of determining, based on luminance data obtained from the image signal for a first frame and a second frame, a polarity of a video signal to be applied to each video signal line during a period of the second frame, the first and second frames being any two consecutive frames and the second frame being a subsequent frame of the two frames; and
a video signal line driving step of applying, during a period of each frame, a video signal of a polarity determined in the polarity determining step to each video signal line without changing the polarity, and
the polarity determining step includes a first polarity determining step of determining, if there is a difference of a predetermined magnitude or more between the luminance data for the first frame and the luminance data for the second frame, the polarity of the video signal to be applied to each video signal line during the period of the second frame to be an opposite polarity to a polarity of a video signal applied to the video signal line during a period of the first frame.

21. The driving method according to claim 20, wherein
the polarity determining step further includes an average luminance calculating step of calculating an average luminance level of the image signal for each frame as the luminance data, and
in the first polarity determining step, if there is a difference of a predetermined first threshold value or more between the average luminance level for the first frame and the average luminance level for the second frame, the polarity of the video signal to be applied to each video signal line during the period of the second frame is determined to be an opposite polarity to a polarity of a video signal applied to the video signal line during the period of the first frame.

22. The driving method according to claim 21, wherein the first threshold value is set to any value between 20% and 40%, inclusive.

23. The driving method according to claim 21, wherein
the liquid crystal display device further includes a polarity difference holding unit that holds, as a polarity difference, a difference between a number of occurrences of a positive polarity and a number of occurrences of a negative polarity, based on the polarities determined in the polarity determining step, and
the polarity determining step further includes a second polarity determining step of determining, if the average luminance level for the second frame is less than or equal to a predetermined second threshold value or greater than or equal to a predetermined third threshold value, the polarity of the video signal to be applied to each video signal line during the period of the second frame to be a polarity whose number of occurrences is lesser, based on the polarity difference.

24. The driving method according to claim 23, wherein
the second threshold value is set to any value between 0% and 10%, inclusive and
the third threshold value is set to any value between 90% and 100%, inclusive.

25. The driving method according to claim 23, wherein the polarity determining step further includes a third polarity determining step of determining, if the polarity difference is greater than or equal to a predetermined fourth threshold value, the polarity of the video signal to be applied to each video signal line during the period of the second frame to be an opposite polarity to a polarity of a video signal applied to the video signal line during the period of the first frame.

26. The driving method according to claim 20, wherein in the video signal line driving step, video signals of different polarities are applied to adjacent video signal lines during a period of each frame.
